(19) United States
(12) Patent Application Publication
(10) Pub. No.: US 2026/0064088 A1
(43) Pub. Date: Mar. 5, 2026

(54) METHOD OF CHANGING FEATURE OF HOME APPLIANCE, AND SERVER AND DEVICE IMPLEMENTING THE SAME

(71) Applicant: LG Electronics Inc., Seoul (KR)

(72) Inventor: Jung Hyub LEE, Seoul (KR)

(73) Assignee: LG Electronics Inc., Seoul (KR)

(21) Appl. No.: 19/319,229

(22) Filed: Sep. 4, 2025

(30) Foreign Application Priority Data
Sep. 5, 2024 (KR) 10-2024-0120825
Apr. 1, 2025 (WO) PCT/KR2025/004303

(51) Int. Cl. G05B 13/02; G10L 15/22; G10L 15/30

(52) U.S. Cl. CPC G05B 13/0265; G10L 15/22; G10L 15/30; G10L 2015/223

(57) ABSTRACT

A method of changing a feature of a home appliance can include receiving a feature command, determining whether the feature command matches a first feature set stored in a database including predetermined feature sets, and in response to failing to match the feature command to the first feature set, providing the feature command to an artificial intelligence (AI) theme module to generate a second feature set. Also, the method can further include in response to the AI theme module failing to generate the second feature set, generating a third feature set based on personalized user information, and changing the feature of the home appliance to correspond to one of the first feature set, the second feature set, or the third feature set.

### CROSS-REFERENCE TO RELATED APPLICATIONS

This application claims priority under 35 U.S.C. § 119 to and the benefit of Korean Patent Application No. 10-2024-0120825, filed in the Republic of Korea on Sep. 5, 2024, and PCT Application No. PCT/KR2025/004303 filed on Apr. 1, 2025, the entireties of which are incorporated herein by reference.

### BACKGROUND

### Technical Field

The present invention relates to a method of changing a feature of a home appliance, and a server and device implementing the same.

### Description of the Related Art

Control methods for devices such as home appliances can be classified into a control method through direct human manipulation and a control method through natural language commands. In the situation of the direct manipulation, a user can control the operation of the home appliance by manipulating a remote controller, buttons or dials on the home appliance, etc. In the situation of the natural language command control, when the user inputs natural language commands to the home appliance, the home appliance recognizes and operates the commands.

However, the natural language commands uttered or input by the user vary from person to person, making it difficult to interpret and translate these commands into actual commands. In particular, the accuracy of natural language command interpretation is required depending on past command input habits and home appliance usage environment of each user.

For example, existing methods for controlling home appliances through natural language commands present significant challenges in accurately interpreting user intent. The inherent variability and ambiguity in human speech often lead to incorrect command execution or recognition failure. Also, many existing systems are constrained by a reliance on rigid, predefined command structures that force the user to memorize specific phrases. This lack of flexibility prevents the system from understanding novel phrasings or compound instructions, which prevents a seamless and intuitive user interaction with the device.

Also, existing methods are further deficient in handling aesthetic customizations, particularly with regards to the selection of color schemes. Conventional home appliances typically offer a limited, predefined palette of colors, restricting the user to a handful of very basic options. These systems are incapable of interpreting abstract or thematic commands, such as “a calming color scheme” or “a vibrant, energetic theme.” This rigidity requires the user to specify explicit colors that are often predefined, which may not align with the user's intentions, which limits personalization and fails to create a smart home environment that can dynamically adapt to a user's changing moods, preferences or new fads.

Thus, a need exists for a method and device for providing personalized services by adaptively receiving user commands and changing specific features of a home appliance.

Also, a need exists for an improved method that can dynamically interpret a wide range of natural language inputs, adapt to individual user speech patterns, and accurately translate ambiguous commands into precise device operations.

Further, a need exists for a more adaptable method of aesthetic customization that can accurately interpret a user's intention from abstract or thematic descriptions to flexibly generate and apply corresponding color schemes.

### SUMMARY OF THE DISCLOSURE

The present specification is intended to solve the above problems and is directed to implementing a method and device for processing commands by accurately reflecting user intent when processing voice commands to change features of electronic devices including home appliances.

In addition, the present specification enables the provision of personalized services by reflecting a user's preference when processing user commands.

In addition, the present specification is directed to providing various recognition methods for user commands to increase the accuracy of changing colors, functions, or voice prompts of home appliances.

Objects of the present invention are not limited to the above objects, and other objects and advantages of the present invention that are not described can be understood by the following description and will be more clearly understood by embodiments of the present invention. In addition, it will be able to be easily seen that the objects and advantages of the present invention can be achieved by devices and combinations thereof that are described in the claims.

According to one embodiment of the present invention, there is provided a method of controlling a home appliance that can dynamically interpret a wide range of natural language inputs, adapt to individual user speech patterns and accurately translate even ambiguous commands into precise device operations.

According to another embodiment of the present invention, there is provided a method of controlling a home appliance that can accurately interpret a user's intention from abstract or thematic descriptions to flexibly generate and apply new corresponding color schemes for more adaptable aesthetic customization.

A method of changing a feature of a home appliance according to one embodiment of the present invention includes a first operation of generating, by a server or a home appliance, a first feature set and a first accuracy corresponding to a feature command, a second operation of generating, by the server or the home appliance, a second feature set and a second accuracy corresponding to the feature command using a theme module disposed in at least one of the server, the home appliance, or an external server when the first accuracy is a reference value or less, a third operation of generating, the server or the home appliance, a third feature set using personalized information corresponding to device information of the home appliance and the feature command when the second accuracy is the reference value or less, and a fourth operation of changing any one of the first feature set, the second feature set, or the third feature set to a feature of the home appliance.

A server according to one embodiment of the present invention includes a preprocessing module configured to receive a feature command input by a home appliance and generate a first feature set and a first accuracy corresponding to the feature command, a theme module configured to generate a second feature set and a second accuracy corresponding to the feature command when the first accuracy is a reference value or less, and a personalization module configured to generate a third feature set using personalized information corresponding to device information of the home appliance and the feature command when the second accuracy is the reference value or less, in which the home appliance sets any one of the first feature set, the second feature set, or the third feature set as a feature of the home appliance.

A server according to another embodiment of the present invention includes a preprocessing module configured to receive a feature command input by a home appliance and generate a first feature set and a first accuracy corresponding to the feature command, a counter theme module configured to transmit the feature command to a theme module of a generative artificial intelligence (AI) external server and receive a second feature set and a second accuracy from the theme module when the first accuracy is a reference value or less, and a personalization module configured to generate a third feature set using personalized information corresponding to device information of the home appliance and the feature command when the second accuracy is the reference value or less, in which the home appliance sets any one of the first feature set, the second feature set, or the third feature set as a feature of the home appliance.

A device according to one embodiment of the present invention includes a command input module configured to receive a feature command, a preprocessing module configured to receive the feature command and generate a first feature set and a first accuracy corresponding to the feature command, a theme module configured to generate a second feature set and a second accuracy corresponding to the feature command when the first accuracy is a reference value or less, a personalization module configured to generate a third feature set using stored personalized information and the feature command when the second accuracy is a reference value or less, and a feature setting module configured to set any one of the first feature set, the second feature set, or the third feature set as a feature.

A method of changing a feature of a home appliance including one or more processors for processing information received from a home appliance, inputting the information to a theme module, which is a generative artificial intelligence (AI) model, to acquire a result according to another embodiment of the present invention includes receiving, by the processor, a feature command instructing a feature change of a first home appliance from the first home appliance or a second home appliance, generating, by the processor, a prompt including the feature command and configuration information of the first home appliance corresponding to the feature command, inputting, by the processor, the prompt to the theme module to acquire a result, and converting, by the processor, the result into a first feature set to be set in the first home appliance.

According to one embodiment of the present invention, there is provided a storage medium installed in a server or a home appliance and including a preprocessing module, a personalization module, and any one of a theme module or a counter theme module, in which the preprocessing module generates a first feature set and a first accuracy corresponding to a feature command, the theme module generates a second feature set and a second accuracy corresponding to the feature command when the first accuracy is a reference value or less, the counter theme module transmits the feature command to a theme module of a generative artificial intelligence (AI) external server when the first accuracy is the reference value or less and receives the second feature set and the second accuracy from the theme module, the personalization module generates a third feature set using personalized information corresponding to device information of the home appliance and the feature command when the second accuracy is the reference value or less, and the storage medium controls the home appliance to set features of the home appliance.

When embodiments of the present invention are applied, it is possible to implement the method and device for processing commands by accurately reflecting user intent when processing voice commands to change the features of the home appliance.

When embodiments of the present invention are applied, it is possible to provide the personalized services by reflecting the user's preference when processing user commands.

When embodiments of the present invention are applied, it is possible to increase the accuracy of changing the colors, functions, or voice prompts of the home appliance by providing various recognition methods user commands.

Effects of the present invention are not limited to the above effects, and various effects of the present invention can be derived from the configuration of the present invention.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a view showing a process in which a home appliance changes features according to a feature command being input according to an embodiment of the present invention.

FIG. 2 is a view showing a process in which a home appliance transmits a feature command to a server according to the feature command being input, receives a feature set from the server, and changes features of the home appliance according to an embodiment of the present invention.

FIG. 3 is a view showing a process in which the server or the home appliance generates a feature set according to an embodiment of the present invention.

FIG. 4 is a view showing a process in which the server processes the feature command according to an embodiment of the present invention.

FIG. 5 is a view showing a process of processing a color command according to an embodiment of the present invention.

FIG. 6 is a view showing a configuration of a personalization module according to an embodiment of the present invention.

FIG. 7 is a view showing a process in which the personalization module uses personalized information to make recommendations according to an embodiment of the present invention.

FIG. 8 is a view showing a process of generating a feature set based on a theme module (320) according to an embodiment of the present invention.

FIG. 9 is a view showing a processing process when fine-tuning a feature set occurs according to an embodiment of the present invention.

FIG. 10 is a view showing a configuration including all components within the home appliance according to an embodiment of the present invention.

FIG. 11 is a view showing a server including a preprocessing module, a theme module, a personalization module, and a database according to another embodiment of the present invention.

FIG. 12 is a view showing a server including a preprocessing module, a personalization module, and a database according to still another embodiment of the present invention.

FIG. 13 is a view showing a configuration of a home appliance, a home appliance for voice processing, and a server according to one embodiment of the present invention.

FIG. 14 is a view showing an interface for changing colors in response to user input commands according to an embodiment of the present invention.

FIG. 15 is a view showing a process of changing colors of a plurality of home appliances according to an embodiment of the present invention.

FIG. 16 is a view showing a process of changing features of a home appliance according to an embodiment of the present invention.

### DETAILED DESCRIPTION OF THE EMBODIMENTS

Hereinafter, embodiments of the present invention will be described in detail with reference to the accompanying drawings so that those skilled in the art to which the present invention pertains can carry out the present invention. The present invention can be implemented in various different forms and is not limited to the embodiments described herein.

In order to clearly describe the present invention, parts not related to the description have been omitted, and the same or similar components are denoted as the same reference numerals throughout the specification. Hereinafter, some embodiments of the present invention will be described in detail with reference to exemplary drawings. In adding reference numerals to components in each drawing, the same components can have the same reference numerals as much as possible even when they are shown in different drawings. In addition, in the description of the present disclosure, when it is determined that a detailed description of a related known configuration or function can obscure the gist of the present disclosure, detailed description thereof can be omitted.

In the description of the components of the present invention, terms such as “first,” “second,” “A,” “B,” “(a),” “(b),” and the like can be used. These terms are only for the purpose of distinguishing one component from another component, and the nature, sequence, order, or the like of the corresponding component is not limited by these terms. When a certain component is described as being “connected,” “coupled,” or “joined” to the other component, the component can be directly connected or joined to the other component, but it should be understood that another component can be “interposed” between the components, or the components can be “connected,” “coupled,” or “joined” through another component.

In addition, the components can be sub-divided for convenience of description in implementing the present invention, but these components can be implemented within a single device or module, or a single component can be implemented by being divided into multiple devices or modules. The features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may.”

Hereinafter, the home appliance described herein is a device including an electronic product. The home appliance can be disposed in homes, offices, or the like and moved and disposed in other locations by people.

In addition, the home appliance described herein can include electronic devices, for example, user terminals, such as a smartphone, a tablet, an iPad, etc. In addition, a hub (e.g., an artificial intelligence (AI) speaker) that can communicate with and control various electronic devices based on wired/wireless communication can also correspond to the home appliance.

In addition, the device described herein, for example, the home appliance, can apply a specific feature set to change a portion of an exterior of the home appliance or modify some elements of its operation.

The feature set includes sub-concepts such as a color set, a speech set related to tone, voice, and the like, a function set related to functions in the operation of the home appliance, etc.

The feature set can include a set of information, such as each feature and its corresponding region, function, etc. For example, the feature set can be formed as follows:
{{first feature information, second feature information, . . . , n^{th} feature information},
{first application region, second application region, . . . , n^{th} application region}}

Alternatively, the feature set can be formed as follows:
{{first feature information, first application region},
{second feature information, second application region}, . . . ,
{n^{th} feature information, n^{th} application region}}

When the application region is predetermined based on the order of the feature information, information on the application region can be omitted from the feature set. For example, when the generative AI module is embedded within the home appliance, such as an on-device, the information on the application region of the home appliance having the generative AI is available, and thus the information on the application region can be omitted.

First, the color set will be described.

The home appliance described in the present specification can change an exterior color according to a specific color set. The color set is a specific region of the exterior of the home appliance to which one or more color information and the color indicated by the color information are applied.

In one embodiment, the color set has the following structure of color information to be applied to n regions of the home appliance, where n is a positive integer. The color information and the region information can be clustered separately.
{{first color information, first region}, {second color information, second region}, . . . {n^{th} color information, n^{th} region}}

For example, when a color set to be applied to a refrigerator is {{#093337, LEFT} and {#093537, RIGHT}}, an RGB color value “093337” can be applied to a left door of the refrigerator, and an RGB color value “093537” can be applied to a right door of the refrigerator. The color set of the present invention can be applied to various home appliances (e.g., an air conditioner, a styler, a digital photo frame, and the like) in which a light source module, such as a light emitting diode (LED) or the like, is disposed in addition to a refrigerator in which the light source module, such as the LED or the like, is disposed and door panels of the refrigerator can be identified. In addition, by linking home appliances, the same or similar color theme can be applied to all home appliances.

The color information is RGB values (hexadecimal) in one embodiment, but the present invention is not limited thereto. For example, three hexadecimal digits of color information can indicate 16 levels for each of R, G, and B. Alternatively, specific color names can correspond to color information. For example, color information such as “RED1,” “RED2,” . . . , “ORANGE1,” . . . , “BLUE1,” and the like can also constitute the color set.

Next, the speech set will be described.

The home appliance described herein can change a tone, intonation, gender, pitch, and the like of a guidance voice according to a specific speech set. The speech set is information indicating features of a voice guidance message.

In one embodiment, the speech set can set the tone, intonation, gender, and the like of the voice message provided by the home appliance according to the message output by the home appliance as follows:
{{first speech information, first voice message},
{{second speech information, second voice message}, . . . ,
{n^{th} speech information, n^{th} voice message}}

For example, a speech set to be applied to an air conditioner can be set as follows when the message indicating the on/off of the air conditioner (on-off message) is a first voice message and a message indicating a temperature or wind direction of the air conditioner (operation message) is a second voice message.
{{Iron Man, on-off message}, {Elsa, operation message}}

In this situation, turning the air conditioner on or off can be guided by a voice of Iron Man, and the operating message such as notifying temperature or changing airflow during the operation of the air conditioner would be guided by Elsa's voice (e.g., since air conditioning is related to being frozen, etc., which a user may find amusing or pleasing).

Next, the function set will be described.

The home appliance described herein can control the operation of the home appliance according to a specific function set. The function set is information that allows a user to specifically define one or more home appliances. A feature set is the information required for a user to configure the functions of one or more specific home appliances.
{{first function information, first function},
{second function information, second function}, . . . ,
{n^{th} function information, n^{th} function}}

For example, in order to set an input source for a TV, the function set can be defined as follows:
{{YouTube, YouTube connection},
{Netflix, Netflix connection},
{Cinebeam, projector connection},
{move to feel-good channel, pet channel}}

When a user speaks or inputs specific function information or selects function information displayed on the TV, the home appliance can provide the corresponding function.

In the above configurations of various feature sets, the user needs to input voice or text information to the home appliance to set a specific feature set, and such information may exceed a range of standardized information predefined for the home appliance. For example, when a user provides a voice or text command to set a specific feature on a home appliance, their input may often fall outside the scope of the standardized commands that the appliance is pre-configured to recognize.

Thus, it is desirable to configure the feature set so that the user intent is reflected even when the user inputs various types of voice/text which may not corresponding to any predefined commands or predefined schemes or themes.

Accordingly, a process of analyzing the voice input by the user and combining the results of the generative AI with the personal information of the user in order to provide an appropriate feature set, which can include dynamically generating entirely new features sets to successfully address the user's intent.

The feature commands described herein are commands that specify or change features via voice or text. However, for convenience of description, the description focuses on voice commands.

In the present specification, feature command processing can be performed by both the home appliance and the server device. Examples of the feature commands include color commands, speech commands, and function commands. A home appliance, a server device (server), or a system composed of one or more devices can store hardware or software for processing feature commands. In addition, the home appliance, the server device (server), or the system composed of one or more devices can receive and execute software for processing feature commands from a remote third device. Processing feature commands using hardware embedded in the device, software stored within the device, or executable software transmitted can be performed by a processor within each device. Alternatively, these hardware or software can operate as processors.

A language model described herein is a large language model (LLM) in one embodiment, and the language model can be embedded within a home appliance or a server device. Alternatively, the language model can be embedded in an external device, and in this situation, the home appliance or the server device can acquire the result of the language model through the external device.

The personalized information described herein includes information generated during the use of the home appliance. In addition, the personalized information according to one embodiment of the present invention includes information generated during the use of other home appliances used by the user of the corresponding home appliance. The personalized information according to another embodiment of the present invention includes information generated during the use of other home appliances disposed in the same space as the corresponding home appliance.

For example, the personalized information applied during the process of changing the color of the refrigerator can include information generated during the use of the air conditioner in a space in which the corresponding refrigerator is disposed. Likewise, the personalized information applied during the process of changing the color of the air conditioner can include information generated during the use of the refrigerator by the user of the corresponding air conditioner or of the air conditioner previously used by the corresponding user.

In addition, the personalized information applied during the process of changing the voice guidance message of the refrigerator includes information generated during the use of the air conditioner in the space in which the corresponding refrigerator is disposed. Likewise, the personalized information applied during the process of changing the voice guidance for an air conditioner includes information generated during the use of the refrigerator by the user of the air conditioner or of the air conditioner previously used by the user.

Likewise, in a home with two air conditioners, the personalized information applied during the process of changing the function of a first air conditioner includes information generated during the use of a second air conditioner in a space in which the first air conditioner is disposed. Likewise, the personalized information applied during the process of changing the function of the second air conditioner includes information generated during the use of the refrigerator or the first air conditioner by the user of the first air conditioner.

In addition, a first home appliance, which is instructed to change a feature of the first home appliance or a second home appliance, can directly receive a voice or text command and process or transmit the commands to a server. Alternatively, the second home appliance, separate from the first home appliance instructed to change a feature, can directly receive the voice or text command and process or transmit the commands to the server.

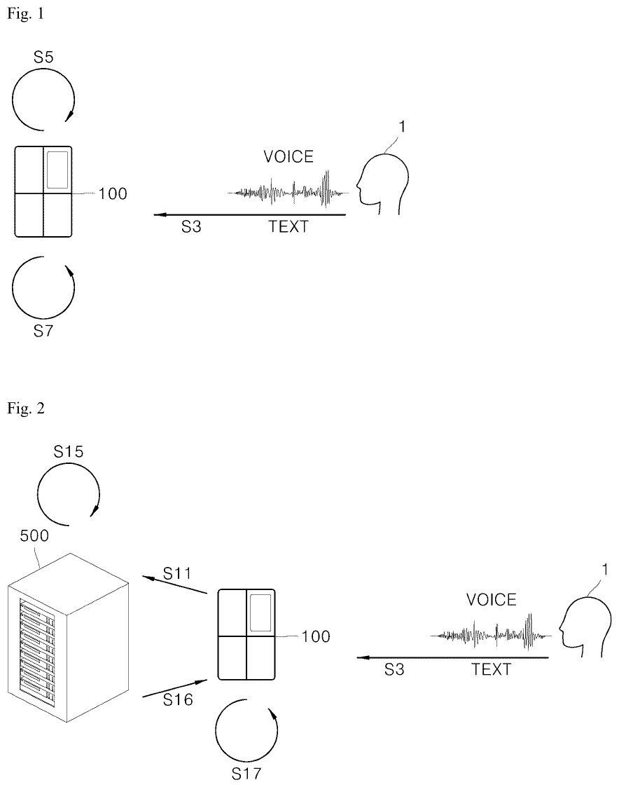

FIG. 1 is a view showing a process in which a home appliance changes features according to a feature command being input according to one embodiment of the present invention.

A user 1 inputs a predetermined command (e.g., voice or text) to a home appliance 100 (S3). Alternatively, the user can input the command through a hub that is connected to and controls multiple electronic devices, such as a mobile terminal or AI speaker, in addition to the home appliance. The command can be input via voice or text. The home appliance (device) 100 determines a feature set corresponding to the command based on the preprocessed result of textualizing the input feature command (S5). In order to determine the feature set, the home appliance 100 can perform a feature set generating process of up to three operations. Once a feature set is determined through the feature set generating process, the determined feature is set in the home appliance 100 (S7).

FIG. 2 is a view showing a process in which a home appliance transmits a feature command to a server according to the feature command being input, receives a feature set from the server, and changes features of the home appliance.

According to an embodiment, the home appliance 100 transmits the input feature command to a server 500 (S11). In this situation, when the input command is a voice command, the home appliance 100 can convert the voice command into text and transmit the feature command, which is the result of preprocessing the text, to the server 500. In this situation, the server 500 can determine a feature set corresponding to the received feature command (S15). The preprocessing process can be performed by the server 500. In this situation, the home appliance 100 can transmit the input command directly to the server 500.

For example, a home appliance can send a user's command to a server, which then interprets the command to understand the user's intention and determines the specific action or feature set change the appliance should perform. The appliance then executes this server-decided command, but embodiments are not limited thereto. According to another embodiment, the decision process for determining the user's intention and generating a corresponding control command or feature set change can be performed locally by the home appliance 100.

In order to determine the feature set, the server 500 can perform the feature set generating process of up to three operations. Once a feature set is determined through the feature set generating process, the server 500 transmits information on the determined feature set to the home appliance 100 (S16), and the received feature is set in the home appliance 100 (S17). However, embodiments are not limited thereto, and according to an embodiment, the feature set generating process can include three or more operations.

As shown in FIGS. 1 and 2, the server 500 or the home appliance 100 can generate an appropriate feature set for the preprocessed feature command. Accordingly, the feature set generating process performed by the server 500 or the home appliance 100 will be described.

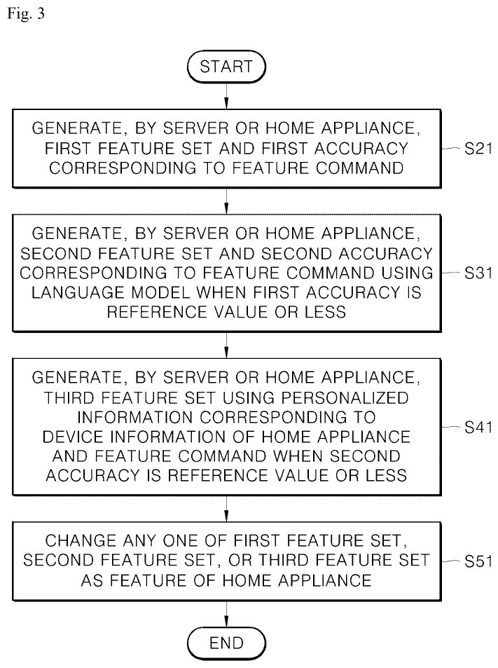

FIG. 3 is a view showing a process in which the server or the home appliance generates a feature set according to one embodiment of the present invention. The process of FIG. 3 can be performed by both the server 500 and the home appliance 100.

The server 500 or the home appliance 100 generates a first feature set and a first accuracy corresponding to the feature command (S21). The first feature set corresponding to the feature command is a feature set in which the feature command corresponds to the name of a specific feature set or to the name of a feature.

That is, the feature set includes one or more feature information and information on a region, area (section, part) or function of a device in which the feature information will be set. When the feature set is a color set, the feature set can include color information and a region, area (section, part)/function to which the color will be applied. When the feature set is a speech set, the feature set can include speech information and a region, area (section, part)/function to which the speech will be applied. When the feature set is a function set, the feature set can include function information, a situation to which the function will be applied, etc.

For example, a color set that is an example of the feature set is shown in Table 1.

TABLE 1

| Name | Color set |
|---|---|
| Orange color | {Color1, Color2, Color3}, |
| | {Region1, Region2, Region3} |
| Sky color | {Color11, Color12, Color13}, |
| | {Region1, Region2, Region3} |
| Green color | {Color21, Color22, Color23}, |
| | {Region1, Region2, Region3} |

In Table 1, when the color command uttered by the user includes color names of the colors constituting the first color set, this indicates that the user has accurately uttered a specific feature set (color set), and thus the server 500 or the home appliance 100 can extract a color set corresponding to the color command. Consequently, in an operation S31, the server 500 or the home appliance 100 determines that the result corresponding to the color command and the accuracy of that result (e.g., the first accuracy) meet criteria.

For example, in a state in which the server 500 or the home appliance 100 stores the contents of Table 1, when a color command uttered by the user is a slightly modified color command, such as “tangerine,” “green,” “turquoise,” or the like, the server 500 or the home appliance 100 can compare similarity between the color command and the names in Table 1 to generate an accuracy of 90 or higher. Assuming that a first accuracy criterion is 85, the server 500 or the home appliance 100 can extract a color set corresponding to the color command from the stored color set in Table 1.

As another example, a speaker set that is an example of the feature set is shown in Table 2.

TABLE 2

| Name | Speech Set |
|---|---|
| Female adult | {Female_Tone1, Female_Tone2}, {Air Conditioner_On/ |
| voice | Off, Air Conditioner_Temperature Control} |
| Boy voice | {Male_Tone1, Male_Tone2}, {Air Conditioner_On/ |
| | Off, Air Conditioner_Temperature Control} |

For still another example, a function set that is an example of the feature set is shown in Table 3.

TABLE 3

| Name | Function set |
|---|---|
| Summer_Heat_{—} | {Temperature1, Airflow1}, {Air Conditioner_{—} |
| Temperature | Temperature, Air Conditioner_Airflow} |
| Early_Summer_{—} | {Temperature2, Airflow2}, {Air Conditioner_{—} |
| Temperature | Temperature, Air Conditioner_Airflow } |

In addition to the above embodiment, the following function sets can be set as follows.

As an example of a feature set applicable to a refrigerator, {Refrigerator_Temperature1, Freezer_Temperature2} can be set under the name “Summer_Heat_Refrigerator.” As an example of a feature set applicable to a refrigerator, {Refrigerator_Temperature3, Freezer_Temperature4} can be set under the name “Autumn_Appropriate Temperature_Refrigerator.”

As an example of a feature set applicable to an air conditioner, {Air Conditioner_Temperature1, Wind Speed_1, Time Information_1} can be set under the name “Cool_Before Bed.” As an example of a feature set applicable to an air conditioner, {Air Conditioner_Temperature2, Wind Speed_2, Time Information_2} can be set under the name “Wake Up_in the Morning.”

In Table 1, Color1, 2, . . . represent specific colors, for example, RGB values as an example. Region1, 2, . . . represent information on a region in which Color1, Color2, . . . will be applied. For example, a color set of {{Color1, Color2, Color3, Color4}, {Region1, Region2, Region3, Region4}} is information indicating that Color1 is applied to Region1, Color2 is applied to Region2, Color3 is applied to Region3, and Color4 is applied to Region4. When the order of the regions is applied to the order of the color information constituting the color set, the region information can be omitted. In an operation S21, the first accuracy can be generated based on the degree of correspondence between the feature command and the feature set/feature information.

For example, in the situation of the color set, the first accuracy can be generated based on the degree of correspondence between the color command and the color set/color information. When the color command is “Set the refrigerator color as orange” (Case 1) and “Set the refrigerator color as tangerine” (Case 2), the server 500 or the home appliance 100 can generate a color set that is an orange-based theme color identically for both color commands.

However, in Case 1, the color command and name are the same, but in Case 2, the color command “tangerine” is not completely the same as the name in Table 1. Accordingly, the server 500 or the home appliance 100 can generate a first color set as the result value for the two color commands, but can generate different accuracies. For example, in Case 1, the generated accuracy can be 100, and in Case 2, the generated accuracy can be 80.

Likewise, in the situation of the speech set, the first accuracy can be generated based on the degree of correspondence between the speech command and the speech set/speech information. When the speech command is “Change the air conditioner voice to an adult female voice” (Case 1) and “Change the air conditioner voice to a girl's voice” (Case 2), the server 500 or the home appliance 100 can generate different speech sets for the two speech commands.

That is, in Case 1, the speech command and the speech information have the same name, but in Case 2, since the name is “girl,” two cases, that is, “female adult” and “boy,” can be generated, resulting in a decrease in accuracy. For example, in Case 1, the generated accuracy can be 100, and in Case 2, the generated accuracy can be 80.

Similar to the color set/speech set, the accuracy for the function set is generated differently depending on whether the voice utterance of the user accurately matches the name.

For example, the method can include a initial step of attempting to understand a user's feature command by matching it against a library of predefined feature sets. These feature sets can be pre-packaged or pre-defined settings for various aspects of the device. For instance, a color feature set named “Orange Color” can contain a coordinated group of specific colors and define which part of the appliance each color applies to. Similarly, a speech feature set can define a “Female adult voice” for all of an air conditioner's audio prompts, while a function set could create a “Summer Heat” preset that automatically adjusts temperature and airflow to specific levels.

Further in this example, when a command is received a first accuracy score can be calculated based on how closely the user's words match the name of a predefined feature set. A direct command such as “Set orange color” may score 100%, while a similar but inexact command like “Set tangerine color” could still be recognized and generate a high, but slightly lower, accuracy score.

However, if a command is ambiguous or does not closely match any existing option, the accuracy score will be lower. If this score falls below a predetermined threshold, it can signal that the system cannot confidently select a predefined setting. In this situation, the process can escalate by sending the command to a theme module, which can use a generative AI model to create a new, custom feature set that fulfills the user's unique request.

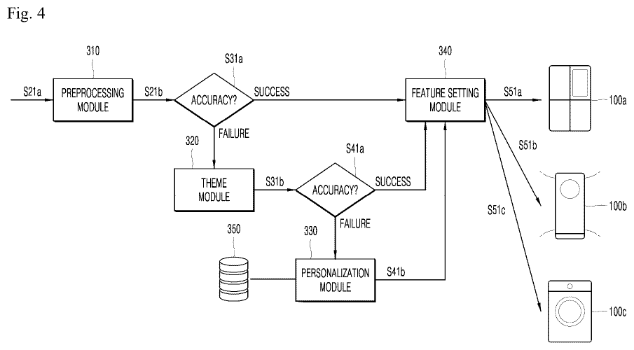

Accordingly, when the first accuracy is a reference value or less, the server 500 or the home appliance 100 uses a theme module (e.g., a language model) to generate a second feature set and a second accuracy corresponding to the feature command (S31). The theme module can be disposed within the server 500, the home appliance 100, or an external language model server. The following description will be made with reference to FIG. 4.

A situation in which the first accuracy is the reference value or less means that a specific feature set cannot be derived from the predefined name-feature set as shown in Tables 1, 2, and 3. In other words, of the initial confidence score (e.g., the first accuracy) is too low, it can be because the user's command does not closely match any of the pre-programmed settings or pre-determined feature sets. For example, the method and system can conclude that none of the available presets are a good enough fit for the user's request and that it needs to use a more advanced process to figure out what the user wants.

For example, in Table 1 and the example of the color command, the user can input a command such as “Change the refrigerator color to Iron Man.” In order to form the feature set, information on a color represented by the character “Iron Man” is needed, and the server 500 or the home appliance 100 cannot immediately generate a result corresponding to the color command using only the information in Table 1.

Accordingly, in this situation, the first accuracy is 0 or a very low value, and in the operation S31, the server 500 or the home appliance 100 inputs a feature command (e.g., a color command) to a language model, for example, an LLM and generates a corresponding second feature set (e.g., a second color set) and second accuracy (S31).

The second accuracy can be calculated by the theme module 320 using an LLM as an example. In this situation, the second accuracy can include two results, such as success or failure, or three results, such as success, neutral, and failure.

The first accuracy can be a value used to determine whether the corresponding command corresponds to a content stored in a database.

While the theme module 320, which uses the LLM as an example, processes data, a result with a second accuracy of 0 (e.g., a failure result) can be generated when data is not output or a range of features is not applicable to the corresponding device (e.g., in the situation of a refrigerator, an unavailable color is output). This corresponds to a process of generating the second accuracy to avoid using a result that cannot be output or is inapplicable while the LLM processes a prompt.

When the prompt instructs the LLM to output two values, such as success or failure, as the accuracy of the result, the second accuracy can be output as one of values 0 and 100 (or a number such as 1).

When the prompt instructs the LLM to output three values, such as success, neutral, or failure, as the accuracy of the result, the second accuracy can be output as one of values 0, 50 (or a number such as 0.5), or 100 (or a number such as 1).

Alternatively, the server 500 or the home appliance 100 rather than the theme module can determine the accuracy (success/failure) using the results generated by the theme module.

In addition, in Table 2 and the example of the speech command, the user can input a command such as “Change the air conditioner voice to the old professor voice.” In order to form a feature set, information on the voice of the “old professor” character is required, and the server 500 or the home appliance 100 cannot immediately generate a result corresponding to the speech command using only the information in Table 2.

Accordingly, in this situation, the first accuracy is 0 or a very low value, and in the operation S31, the server 500 or the home appliance 100 inputs a feature command (e.g., a speech command) to a language model, for example, an LLM and generates a corresponding second feature set (e.g., a second color set) and second accuracy (S31).

Similar to the color set/speech set, the accuracy of the feature set is generated to be the reference value or less when the user does not utter a voice that accurately corresponds to the name.

Here, the second accuracy is accuracy information generated by the LLM as an example. For example, when entering a prompt into the LLM, the prompt can indicate that the accuracy of the information produced by the prompt should also be calculated when producing the results.

For example, if a user issues a creative or abstract command such as “Change the refrigerator color to Iron Man,” the system may not find a matching preset in its library, resulting in a very low initial accuracy score. This can be a trigger for using the theme module. The command can be passed to a generative AI module, which can use its knowledge to interpret the request. The AI module would understand the “Iron Man” theme and can generate a brand new color set, e.g., a combination of red and gold, along with instructions on how to apply it to the refrigerator's different lighting zones. A similar process can apply to an audio command, such as “Change the voice to an old professor voice.”

The method can also include producing a second accuracy score for this newly generated color set or feature set. This second accuracy score can serve as a type of confidence check for indicating whether the generated result is successful and applicable to the device. For example, if the AI module successfully creates a valid color scheme, it can return a “success” score. However, if the command was impossible to fulfill or resulted in colors the appliance cannot display, it can return a “failure” score. This validation step can help ensure that only logical and functional feature sets are applied, in order to prevent errors that could arise from abstract or imaginative user commands.

In more detail, the language model used in the present invention according to an embodiment can include a language model such as ChatGPT, which is an example of LLM. In addition, the language model used in the present invention can be a language model specialized for generating a feature set. The language model can be embedded and executed within the server device 500 or the home appliance 100. Alternatively, the language model can be disposed to be executed outside the server device 500 or the home appliance 100 and can generate results through prompt input.

According to an embodiment, the generative AI module can be LLM-agnostic, such as ChatGPT, but embodiments are not limited thereto. For example, according to another embodiment, the generative AI module can be based on a propriety LLM model that is trained or fine turned for the specific task of controlling home appliances.

When commands are simply applied to a generative AI, such as an LLM, without the above prompts, the desired results cannot be generated depending on factors such as the number of home appliance panels, the type of home appliance, or the like, and thus in the embodiments of the present invention, prompts are input to the generative AI such as an LLM, and the prompts can include various information.

Various data that the prompt can include, that is, data included in the prompt can include identification information on the home appliance of the user and configuration information of the home appliance of the user. For example, the identification information on the home appliance is information on a home appliance registered to a server, a home appliance registered to the user's account within the server, and the like as a device the user actually owns in one embodiment.

In addition, important information for each home appliance can be included in the prompt to set an accurate feature set. The input data required to generate a function set for the operation of the refrigerator can include user input commands, refrigerator-related information (such as a refrigerator unit of the user, an installation location of the refrigerator, whether the refrigerator has a refrigerator/freezer compartment, and the number of doors of the refrigerator), and a current status of the refrigerator (such as power on/off status, current storage temperature setting, type of items stored, the number of times the door was opened or closed over the past day, etc.). Consequently, the temperature of the refrigerator can be controlled more accurately.

The input data required to generate a function set for the operation of an air conditioner can include user input commands, air conditioner-related information (such as an air conditioner unit of the user, an installation location of the air conditioner), and a current status of the air conditioner (such as power on/off status, current temperature and air direction settings, air conditioner manipulation information over the past day, etc.). Consequently, the wind speed or direction of the air conditioner can be controlled more accurately.

Meanwhile, the home appliance can transmit specific information of a home appliance, component-related information, and state information to the server, or the home appliance can store the corresponding information and then provide the information to the preprocessing module 310 or the theme module 320. In addition, the home appliance can identify command utterance recognition and transmit recognized commands between home appliances. For example, when a refrigerator-related command is input to an oven, the oven can transmit or relay the input command to the refrigerator.

That is, the server or the home appliance can input information on the type of home appliance targeted by the feature command, configuration information or state information of the home appliance, the range of features that can be set in the home appliance, and sample control commands to the theme module 320. Consequently, the theme module 320 can generate results appropriate for various characteristics of the home appliance.

The personalization module 330, which is an example of the recommendation AI module, can store personal information, such as a user's history of using home appliances and the like, and generate a personalized feature set using the stored personal information.

When the second accuracy is the reference value or less in the operation S31, the server 500 or the home appliance 100 generates a third feature set using personalized information and feature commands corresponding to the device information of the home appliance (S41). The device information can include at least one of the identification information of the home appliance whose features will be changed and the type of the device (a refrigerator, an air conditioner, or the like). In addition, the personalized information is, for example, information on the feature set that has been set for the home appliance. Alternatively, information generated while the corresponding user uses another home appliance can also be included in the personalized information.

For example, if even the generative AI is unable to produce a successful or applicable result regarding the second accuracy score, the method can turn to personalization to generate a “third feature set.” This can include analyzing the user's past preferences and behaviors across their smart home ecosystem. This personalized information can include the history of feature sets previously applied to the specific home appliance, as well as preferences the user has shown on other connected devices. By leveraging this historical data, the method can make an educated recommendation tailored to the user's established tastes to provide a relevant option even when the initial command was too ambiguous for the preceding steps to interpret.

Next, the server 500 or the home appliance 100 changes one of the first feature set, the second feature set, or the third feature set to the feature of the home appliance (S51). Consequently, for example, the exterior color of the home appliance can be changed based on the user intent. For example, the method can include applying the successfully generated feature set (e.g., whether it was the predefined, AI-generated, or personalized option) to the home appliance. This can include directly changing the device's characteristics, such as altering its exterior color, to match the user's original command and intent.

In one embodiment, the server 500 or the home appliance 100 can determine whether to use the first feature set or the second feature set using the first accuracy and the second accuracy. When both the first and second accuracies are low, the third feature set can be used. For example, the system can compare the confidence scores of the first two results (e.g., the one from the predefined library and the one from the AI model) to decide which is the better match for the user's command. If neither of those options yields a high confidence score, then system can use the third, personalized feature set.

In another embodiment, the server 500 or the home appliance 100 can select a feature set similar to a feature set previously used by the user among the three feature sets generated after performing the operations S21, S31, and S41.

When an embodiment related to the color set of the present invention is applied, in a home appliance that can change its exterior to various colors, the server 500 or the home appliance 100 can first search for a basic theme color in response to a voice or text command input by the user (S21), and at this time, when there is no color that exactly matches the color, a color set (color information) can be secured through a language model, for example, a generative AI (S31). Information that can be included in a color set includes, in addition to RGB color information, information on changes in output brightness. For example, in addition to color changes, a color set can also include changes in brightness.

However, since the language model, that is, the generative AI, do not have the past color outputs of the user, when the language model (generative AI) cannot provide a color value in response to the voice/text command of the user, the server 500 or the home appliance 100 can determine an AI color through a recommendation AI server that reflects past color usage pattern data of the user (S41). The recommendation AI server can be embedded in the home appliance to perform data processing or generate or process data within various environments, such as a cloud server-based system, an on-device system, a distributed server system (multiple servers), etc.

When the embodiment of FIG. 3 is applied, when a voice/text command to change the color theme is recognized in a home appliance having an LED panel and capable of changing the exterior color (e.g., a mood-up refrigerator, a mood-up air conditioner, or the like), even when the color theme included in the input command is not predefined, the generative AI including an LLM such as ChatGPT can be used to generate a color theme that matches the user intent and change the refrigerator color.

In addition, when the generative AI is used, in order to perform a feature set according to the user intent, data (e.g., prompts) input to the generative AI can be generated, or the data can be input to the generative AI to accurately output a feature set according to each situation within a short time or with minimal processing.

In one embodiment, a home appliance, a server device, or the like can input information on the home appliance as additional input data to the generative AI, in addition to the user input command, to generate the result appropriate to the user intent quickly and with minimal calculation. To this end, the information on the home appliance, which can be included in the additional input data, includes information on the feature command. The additional input data can include a display panel layout related to the exterior of the home appliance, the range of colors the panel can generate, the type of home appliance, etc. The information that can be added can vary depending on the type of feature instructed by the feature command. The home appliance or the server device can store additional input data corresponding to the type of each feature, categories of the additional input data, and the like and update the data based on the results of the generative AI.

By coupling a generative AI server or a recommendation AI server with the natural language processing (NLP) server for speech recognition, areas that were previously impossible with only the NLP server, such as identifying the user intent and generating color themes, can be processed.

In FIG. 3, the reference value (threshold) compared to the accuracy can be set in various ways. In this specification, accuracy is compared to the reference value (threshold), such as below or above the reference value. If the accuracy does not meet the reference value, a new feature set is acquired, thereby improving the accuracy of the feature set.

That is, the response to non-predefined color themes or user utterances is possible, thereby satisfying various user utterances and requests related to changing the color of the home appliance, such as a refrigerator, an air conditioner, etc. For example, when the user inputs a command such as “I'm feeling depressed right now, change the color” or “Recommend a color that suits me,” the server 500 or the home appliance 100 can generate an optimal color based on the user's command and apply the color to the home appliance, such as a refrigerator, an air conditioner, etc.

The process of FIG. 3 can also be applied to the speech set or the function set like the color set.

When an embodiment related to the speech set of the present invention is applied, in a home appliance that can change its voice guidance message using various voice utterance characters, the server 500 or the home appliance 100 can first search for a basic theme speech in response to a voice or text command input by the user (S21), and at this time, when there is no exactly matched speech, a speech set (speech information) can be secured through the language model, for example, the generative AI (S31).

However, since the language model, that is, the generative AI, do not have the past preferred speech results of the user, when the language model (generative AI) may not provide a specific speech information in response to the voice/text command of the user, the server 500 or the home appliance 100 can determine AI speech information through a recommendation AI that reflects past speech selection pattern of the user (S41).

When the embodiment of FIG. 3 is applied, when the voice/text command to change the speech theme is recognized in the home appliance having an LED panel and capable of changing the speech characteristics of the voice message of the home appliance, even when the speech theme included in the input command is not predefined, the generative AI can be used to generate a speech theme according to the user intent and change the tone, intonation, and the like of the voice guidance message of the home appliance.

By coupling the generative AI server or the recommendation AI server with the NLP server for speech recognition, areas that were previously impossible with only the NLP server, such as identifying the user intent and generating speech themes, can be processed.

That is, the response to non-predefined speech themes or user utterances is possible, thereby satisfying various user utterances and requests related to changing the guidance message of the home appliance, such as a refrigerator, an air conditioner, etc. For example, when the user inputs a command such as “I'm feeling depressed right now, change to the voice message to a cheerful one” or “Recommend a voice message that matches the current music,” the server 500 or the home appliance 100 can generate optimal speech information based on the user's command and apply the optimal speech information to the guidance message of the home appliance, such as a refrigerator, an air conditioner, etc.

In the situation of a refrigerator as an example, when a functional command such as “There are a lot of new foods in the refrigerator, so refrigerate them well” is input, the server 500 or the home appliance 100 can generate a function set including optimal functional information for the user's command and apply the optimal functional information to the function settings of the home appliance such as a refrigerator, an air-conditioner, etc.

For example, by integrating generative AI with speech recognition, the present invention according to embodiments moves beyond simple keyword matching to a deeper understanding of user intent. This allows the method to successfully interpret and execute abstract or non-predefined commands that fall outside the scope of existing systems. In this way, the method can dynamically generate and apply optimal feature sets in response to a wide variety of user inputs, creating a more flexible and intuitive user experience.

FIG. 4 is a view showing a process in which the server processes the feature command according to one embodiment of the present invention. A server is a single server and can perform functions to be described below. Alternatively, the server is multiple server clusters and can perform functions to be described below. The embodiment of FIG. 4 can be applied to color commands, speech commands, function commands, or the like included in feature commands.

Accordingly, according to one embodiment of the present invention, a single server can include individual modules. According to another embodiment of the present invention, each module to be described below can be a server, and these servers can be included in a single server cluster.

According to still another embodiment of the present invention, two or more modules can constitute a single server.

A preprocessing module 310 of the server receives a voice/text command (S21a). In addition, the input command is preprocessed and converted into a feature command, and the corresponding first feature set and first accuracy are generated (S21b).

The preprocessing module 310 can be, for example, a legacy NLP module, and can perform a primary intent analysis on the voice or text command input by the user, and if successful, perform feature control of the home appliance.

For example, when the input color command is “Change color to a spring theme,” the preprocessing module 310 preprocesses the input command to extract a color command “spring theme.” In addition, when a color set corresponding to “spring theme” is pre-stored in the preprocessing module 310, the preprocessing module 310 generates the corresponding color set and its accuracy.

When the input command is “Change color to a spring breeze theme,” the preprocessing module 310 preprocesses the input command to extract the color command “spring breeze theme.” However, unlike the above embodiment, since there is no color set corresponding to “spring breeze theme,” the preprocessing module 310 can generate the color set corresponding to the most similar “spring theme” and its corresponding accuracy score (e.g., 60)

For example, when the input speech command is “Change the voice message to a refreshing voice,” the preprocessing module 310 preprocesses the input command to extract the speech command “refreshing theme.” In addition, when a speech set corresponding to “refreshing theme” is pre-stored in the preprocessing module 310, the preprocessing module 310 generates the corresponding speech set and its corresponding accuracy score.

When the input command is “Change the voice message to a refreshing and bright theme,” the preprocessing module 310 preprocesses the input command to extract the speech command “refreshing and bright theme.” However, unlike the above embodiment, since there is no speech set corresponding to “refreshing and bright theme,” the preprocessing module 310 can generate the speech set corresponding to the most similar “refreshing theme” and its accuracy (e.g., 60).

When the accuracy of the feature set generated by the preprocessing module 310 exceeds the reference value, this indicates a successful accuracy, and thus a feature setting module 340 can apply the feature set generated in an operation S21b to home appliances 100a, 100b, and 100c (S51a, S51b, S51c).

On the other hand, when the accuracy of the feature set generated by the preprocessing module 310 is equal to the reference value or less, this indicates a failure in accuracy, and thus the theme module 320 can generate a feature set and accuracy corresponding to the feature command (S31b).

That is, when the analysis of the feature change intent of the user through the NLP module (or the NLP server), which is an example of the preprocessing module 310, fails, the theme module 320, which is an example of the LLM server, processes the feature command (e.g., color command) of the user to perform secondary intent analysis and extract intent analysis and color theme color hex values.

In this situation, when the theme module 320 is implemented in a device (e.g., a device provided by an external third party) other than the preprocessing module 310, the server 500 can input a prompt for acquiring information in a manner agreed upon in advance with the theme module 320 to the theme module 320.

In addition, even when the theme module 320 is an external or internal server, information necessary for generating various feature sets (e.g., color set formats, examples of color sets corresponding to color commands, and the like) can be input to the theme module 320.

For example, when the preprocessing module 310 generates a color command as “The weather is too hot today, change the color to cool” to the command “The weather is hot, change the color to cool” but there is no predefined color set corresponding to the cool color, the color command can be input to the LLM, which is an example of the theme module 320, to generate a color set (S31b).

In addition, when a secondary stage of identifying the color change intention of the user is successful based on the accuracy result generated by the LLM, the theme module 320, for example, can extract the color theme hex values for applying the color theme generated by the generative AI, and the feature setting module (e.g., the color setting module) 340 can change panel colors of the home appliances 100a, 100b, and 100c such as a refrigerator and the like (S51a, S51b, S51c). In one embodiment, the intent identification includes generating a color set corresponding to the color command of the user. In the present specification, the intent identification of the user input feature command includes a process of generating a feature set corresponding to the feature command.

During this process, when the theme module 320 is an external server, an LG ThinQ server can include the feature setting module 340 that can set the feature set (e.g., a color set) generated by the theme module 320 in the home appliance.

Meanwhile, when the accuracy of the feature set (e.g., the color set) generated by the theme module 320 is the reference value or less (S41a), this indicates a failure in accuracy, and thus a personalization module 330 can generate a feature set corresponding to the feature command (S41b).

When the theme module 320, for example, fails to analyze the feature change intent of the user through the generative AI or the LLM (i.e., fails to identify the secondary feature intent), the personalization module 330, for example, a recommendation AI server, can recommend the feature. During this process, the theme module 320 can determine whether the user intends to make a recommendation and can also generate whether the user wants a feature recommendation from the recommendation AI server as an accuracy result.

For example, when the input color command is “Recommend a color theme that suits me today,” the accuracy of the color set generated in the operations S21b/S31b can be the reference value or less, resulting in a failure. Alternatively, the theme module 320 can respond that the LLM cannot generate the color set. In this situation, the personalization module 330 can use history information on the previous color settings of the user for the home appliance.

The personalization module 330 extracts a color theme generated to be preferred by the user based on the color usage patterns of the user on the home appliances and transmits the color themes to the color setting module (an embodiment of feature setting module 340) (e.g., the LG ThinQ server) to change the color theme of the product.

When the embodiment of FIG. 4 is applied, the preprocessing module 310 can perform different preprocessing depending on whether the command includes the type or name of the home appliance. In one embodiment of the invention, when the command includes the type or name of the home appliance, the preprocessing module 310 preprocesses the command based on the corresponding device. In another embodiment of the invention, when the command includes the names or types of a plurality of home appliances, the preprocessing module 310 can preprocess the command based on the specific home appliance that has recognized the command utterance of the user. In still another embodiment of the invention, when the name or type of the specific home appliance is not included, the preprocessing module 310 can preprocess the command based on the specific home appliance that has recognized the command utterance of the user or preprocess the command by specifying the home appliance corresponding to the command.

In addition, when results generated from the theme module 320, which uses an LLM as an example, are processed, feature settings can be performed differently depending on whether the result includes the type or name of the home appliance.

In one embodiment of the invention, when the command includes the type or name of the home appliance, the theme module 320 generates the result based on the corresponding device. In another embodiment of the invention, when the command includes the names or types of a plurality of home appliances, the theme module 320 can generate the result based on the specific home appliance that has recognized the command utterance of the user In still another embodiment of the invention, when the name or type of the specific home appliance is not included, the theme module 320 can generate the result based on the specific home appliance that has recognized the command utterance of the user or generates the result by specifying the home appliance using the command.

For example, according to an embodiment, the method can include a three-tiered hierarchical process to interpret and execute a user's command. The initial stage can be handled by the preprocessing module 310, which can function as a natural language processing (NLP) system. The preprocessing module 310 can receive the user's raw voice or text input and attempts to match it to a library of predefined feature sets.

For example, if a user requests a “spring theme” and that theme exists as a preset, the preprocessing module 310 will find a direct match, generate a high accuracy score, and apply the corresponding feature set. If the command is similar to a predefined feature set but not identical, such as a “spring breeze theme,” the preprocessing module 310 can identify the closest existing option (e.g., “spring theme”) but assign a lower accuracy score. If this score is above a predetermined threshold, the matched feature can be applied, and if it is too low, the command can be escalated to the next stage for a more advanced analysis.

Further in this example, when the initial processing by the preprocessing module 310 fails to find a confident match, the command can be passed to a secondary theme module 230, which can be powered by a generative Artificial Intelligence, such as a Large Language Model (LLM). This stage is configured to understand the user's intent behind abstract or creative commands that do not correspond to any predefined setting.

For instance, if a user says, “The weather is hot, change the color to cool,” the theme module can interpret the abstract concept of “cool” and dynamically generate a completely new color set, such as involving shades of blue and white. The theme module 230 can also assess its own result to determine if it has successfully created a valid and applicable feature set (e.g., generate a second accuracy score). If successful, this newly generated set can be sent to be applied to the home appliance.

Further still in this example, if both the predefined matching and the generative AI analysis fail to produce a viable result, the method can proceed to the personalization module 330. The personalization module 330 can act as a type of recommendation engine to leveraging the user's historical data and past preferences to generate a suitable feature set. This can be particularly useful for vague commands or direct requests for a recommendation, such as, “Recommend a color theme that suits me today.” By analyzing the user's past color selections and usage patterns, the personalization module 330 can suggest a feature set that is tailored to their individual tastes. This personalized option can then be applied to the device to help ensure that a relevant response can be provided even when the user's intent is not explicitly clear from the initial command.

The above description can also be applied to various feature sets, such as a speech set, a function set, etc.

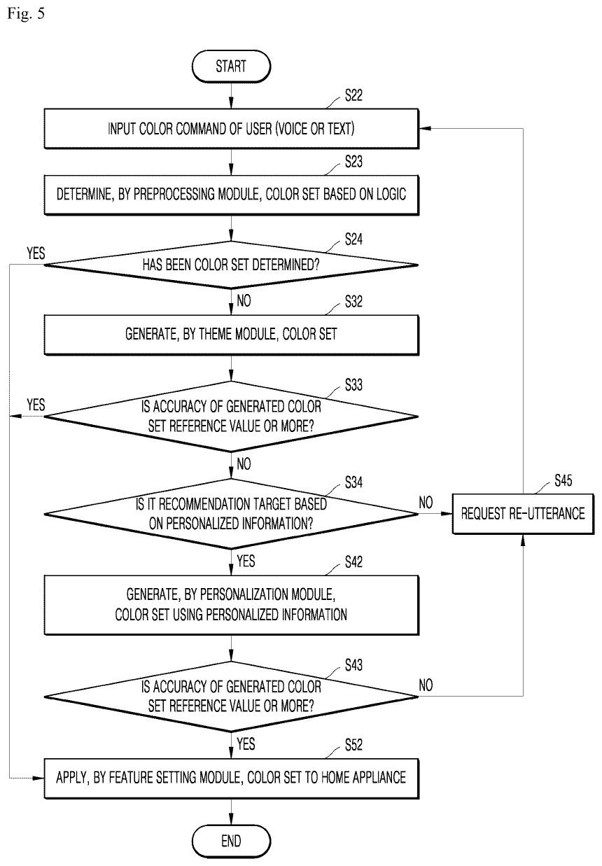

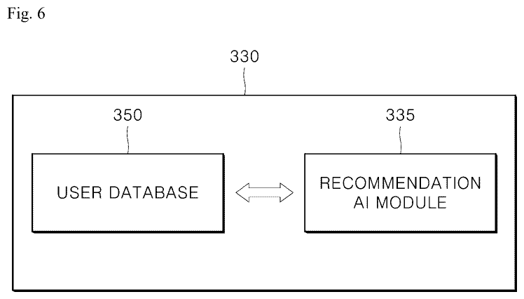

FIG. 5 is a view showing a process of processing a color command according to one embodiment of the present invention.

The user inputs a color command via voice or text (S22). The preprocessing module 310 verifies a color set based on logic (S23). That is, the preprocessing module 310 extracts keywords from the color command (utterance or text command) input by the user. In addition, the preprocessing module 310 generates the color set corresponding to the intent of the color command input by the user based on the logic that compares the extracted keywords with names, keywords, and the like of pre-stored color sets. This includes a process in which the preprocessing module 310 identifies the intent of the color command and generates an appropriate color set.

When the color set is determined in an operation S23 (when the user intent to change the color is identified) (Yes in an operation S24), the feature setting module 340 applies the determined color set to the home appliance (S52).

When the color set is not determined in the operation S23 (when the user intent to change the color is not identified) (No in the operation S24), the theme module 320 generates a color set (S32). For example, the server 500 or the home appliance 100 uses an LLM (GPT) or the like to identify the color intent from the color command input by the user (S32). In one embodiment, the server 500 or the home appliance 100 can include a theme module 320, and this theme module 320 can be configured as software or hardware. A control unit, processor, CPU, etc., which controls the server 500 or the home appliance 100, can load the theme module 320 configured as software into memory and execute it, or input predetermined information into a hardware chip which implements the theme module 320 and obtain a result. The server 500 or the home appliance 100 determines whether the accuracy of the generated color set is the reference value or more (S33). For example, the server 500 or the home appliance 100 determines whether the color set generated in an operation S32 is appropriate for the color intent of the color command input by the user. As the determination result, when the accuracy is the reference value or more, an operation S52 is performed.

Meanwhile, when the accuracy is low in an operation S33, the server 500 or the home appliance 100 determines whether the input color command is a recommendation target based on personalized information (S34). For example, when the input color command is “Make it my favorite color,” it can be determined that the color command is a request for a color based on the personalized information.

On the other hand, when the input color command is “Oh, color of the refrigerator is weird, isn't it?” it is difficult to determine whether the color command is a request for a color change based on the personalized information.

This determination is made, in one embodiment, by the theme module 320 determining, during the color set generating process for the color command, that the color command is unlikely to be a color change.

When it is determined that the color command is a recommendation target based on the personalized information in an operation S34, the personalization module 330 generates a color set using the personalized information (S42). In addition, the server 500 or the home appliance 100 determines whether the accuracy of the generated color set is the reference value or more (S43). For example, the server 500 or the home appliance 100 determines whether the color set generated in an operation S42 is appropriate for the color intent of the color command input by the user. As the determination result, when the accuracy is the reference value or more, an operation S52 is performed.

When the accuracy is not the reference value or more even in an operation S43 (No in the operation S43), the home appliance 100 requests re-utterance (S45). For example, the home appliance 100 can request re-input by newly uttering a command, such as “Please say again to change the color.”

For example, according to an embodiment, a method can include a hierarchical, multi-stage process for interpreting a user's color command to ensure accuracy and fulfill user intent. The process can begin with the preprocessing module that first attempts to match the user's command to a predefined, logic-based color set through keyword analysis. If a sufficiently accurate match is found, the color set can be applied to the home appliance (S23).

If this initial attempt fails, the command can be escalated to a theme module which can utilize a generative AI model to interpret the user's abstract or creative intent and generate a new, corresponding color set (S32).

Further, if this AI-generated feature set also fails to meet the required accuracy threshold, a further attempt can include a personalization module generating a color set based on the user's historical data and preferences to see if personalization may be appropriate (S34 and S42).

If any of these three stages (e.g., predefined, AI-generated, or personalized) yields a successful result, the feature can be applied to the home appliance, otherwise, if all attempts fail or if one or more attempts fail, the method can include prompting the user to re-input the command to avoid an incorrect interpretation (S45).

According to other embodiments, the method can include prompting the user to re-input the command after any one of or all of the stages (e.g., S45 can follow one or more of S24, S33, S34, and S43).

FIG. 6 is a view showing a configuration of a personalization module according to one embodiment of the present invention.

The personalization module 330 can include a user database (DB) 350 that stores color information set by the user, and a recommendation AI module 335. The personalization module 330 can extract a specific color set from the user database based on the past usage patterns of the user for the color command. When the personalization module 330 is disposed in the server 500, the recommendation AI module 335 can be implemented as the recommendation AI server. Meanwhile, when the personalization module 330 is disposed in the home appliance 100, the recommendation AI module 335 can be configured as a software component or hardware component within the home appliance 100.

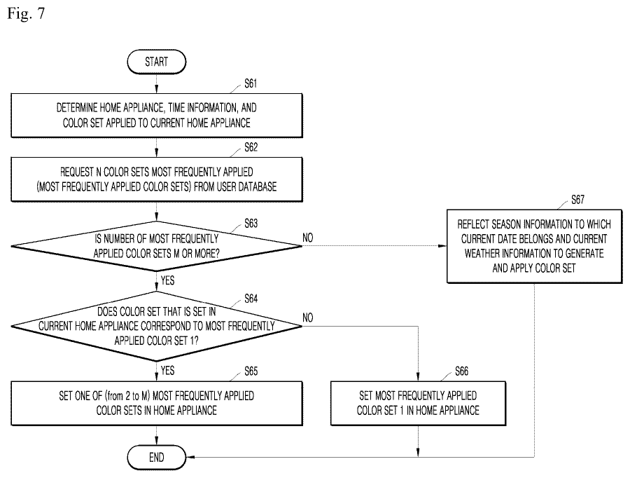

FIG. 7 is a view showing a process in which the personalization module uses personalization information to make recommendations according to one embodiment of the present invention. The operation S42 will be described in more detail.

The personalization module 330 determines the home appliance, time information, and the color set currently applied to the home appliance (S61). In addition, the personalization module 330 requests n color sets most frequently applied (most frequently applied color sets) for the corresponding home appliance or other home appliances used by the user from the user database 350 (S62). “n” can be 2 or more.

When the number of most frequently applied color sets extracted as a result of the request is not m (No in an operation S63), the number of most frequently applied color sets is insufficient, and thus the personalization module 330 reflects season information of a current date or current weather information to generates a color set and applies the color set to the home appliance (S67). For example, “m” can be 2 in one embodiment.

When there are m or more most frequently applied color sets (Yes in the operation S63), the number of most frequently applied color sets secured by the personalization module 330 is sufficient, and thus each most frequently applied color set is compared with the color set currently set in the home appliance. For example, the personalization module 330 determines whether Most frequently applied color set 1 is the same as the color set currently set in the home appliance. In addition, when Most frequently applied color set 1 and the color set currently set in the home appliance are the same (Yes in an operation S64), the personalization module 330 sets one of the m most frequently applied color sets, excluding Most frequently applied color set 1, in the home appliance (S65). When Most frequently applied color set 1 and the color set currently set in the home appliance are not the same (No in the operation S64), the personalization module 330 sets Most frequently applied color set 1 in the home appliance (S66).

In the above embodiment, n or m can be set in various ways.

The embodiment of FIG. 7 can be applied to a process of recommending a feature set based on a usage pattern of a user. FIG. 7 shows an example in which the personalization module 330 extracts the top two most frequently applied values from a list of the color sets (color theme hex values) applied until now among the color sets and applies a theme different from the currently applied color set.

When it is difficult to extract two most frequently applied values due to an insufficient user database, color themes can be recommended based on the current date, time, weather, and the like and applied to the home appliance.

Next, the process of generating a feature set using the theme module 320 will be described.

When a user uses a predefined name for a product as a feature command to use a specific feature of the device, the preprocessing module 310 included in the server 500 or the home appliance 100 can provide a feature set corresponding to the corresponding feature.

Meanwhile, when the user utters a feature command that is commonly used in the society to which the user belongs during the process of uttering the feature command, the theme module 320 can generate a feature set using a language model.

For example, the personalization module query a database to identify the color sets the user has most frequently applied in the past. If sufficient data is available, it selects the user's top-ranked preference. Also, to ensure variety, if that color set is already active on the device, it can instead apply the next most-frequently used color set. In situations where the user's history is insufficient to determine a clear preference, the personalization module can generate a new color set based on external contextual information, such as the current season or weather, to provide a relevant and suitable recommendation.

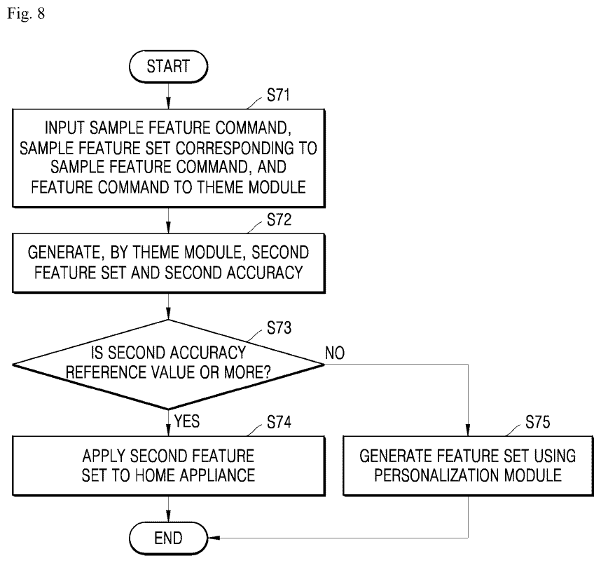

FIG. 8 is a view showing a process of generating a feature set based on the theme module 320 according to one embodiment of the present invention.

The server 500 or the home appliance 100 extracts feature commands and feature sets that can be input to the theme module 320 from an internal storage. These are referred to as sample feature commands and sample feature sets. In addition, the server 500 or the home appliance 100 inputs the sample feature commands, sample feature sets, and feature commands to the theme module 320 (S71).

Consequently, the theme module 320 generates the second feature set and the second accuracy (S72). When the second accuracy is the reference value or more (S73), the server 500 or the home appliance 100 can apply the second feature set to the home appliance 100 (S74). On the other hand, when the second accuracy does not meet the reference value or more, the server 500 or the home appliance 100 generates a feature set using the personalization module 330.

The sample feature command is an example of commands that the user can utter. The sample feature set is a feature set corresponding to the sample feature command.

For example, the sample color command and a corresponding sample feature command are as follows.

TABLE 4

| Sample feature | |
|---|---|
| command | Sample feature set |
| Make it Iron Man | {“#FF0000,” “#FF0700,” “#FF8C00,” “#C0C0C0”} |
| color | |
| Make it autumn | {“#FF7F50,” “#FFA500,” “#FFB700,” “#800000”} |
| color | |
| . . . | . . . |
| Make it giraffe | {“FFD700,” “#8B4513,” “#060400,” “#FFA500”} |
| color | |

When the sample color command and the sample feature set are input to the theme module 320 and the color command is input, the theme module 320 can apply a relationship between the sample feature command and the sample feature set to generate a color set (second color set) corresponding to the color command.

In one embodiment, when the theme module 320 is configured based on a language model such as ChatGPT, the server 500 or the home appliance 100 can input a prompt to the theme module 320. In one embodiment, the server 500 or the home appliance 100 can include the sample color commands and the sample feature sets in a few shots.

The prompt input to the theme module can include instructions, sample feature commands, etc. In one embodiment, the prompt can include instructions to be input to the theme module 320 and a message provided by the server 500 or the home appliance 100 to the theme module 340.

In addition, the message can include the sample feature command (sample color command) and the corresponding sample feature set (sample color set) as shown in Table 4. Accordingly, the theme module 320 can generate a color set corresponding to a color command (user_request) uttered by the user.

In order to enable the theme module 320 to generate more accurate results, the server 500 or the home appliance 100 can additionally input information on the region, country, or the like to which the user uttering the feature command belongs to the theme module 320. For example, the color of an apple perceived by a Korean can differ from the color perceived by an American. Accordingly, the server 500 or the home appliance 100 inputs information on the region or country where the feature command has been uttered to the theme module 320, thereby enabling the accurate generation of a feature set, such as colors, sounds, functions, or the like commonly used by people belonging to a specific region or country.

In one embodiment, when the theme module 320 is a GPT, the home appliance 100 or the server 500 can instruct a GPT to extract four theme colors in hexadecimal format using a GPT prompt.

In addition, when it is determined that the color command uttered by the user wants a recommendation, the theme module 320 is instructed to return a “True” value (a region instructed to return whether a recommendation is desired). The home appliance 100 or the server 500 can also add color therapy content to prompt instructions to generate a color theme according to a situation. The home appliance 100 or the server 500 can present a few examples (sample color commands and sample color sets) in a few shot and include the examples in the prompt to output a list of recommended flags or RGB color hexadecimal values that the home appliance 100 can set.

When applied to a three-door kimchi refrigerator, the home appliance 100 or the server 50 can change the number of extracted color hexadecimal values from four to three.

In addition, when applied to other types of home appliances, such as an air conditioner, an oven, and the like, the color hexadecimal values output based on the number of panels on the door, side surfaces, and the like of the home appliance can be changed and set.

Meanwhile, the personalization module can use personalized information to generate a feature set corresponding to the feature command.

The personalization module 330 included in the server 500 or the home appliance 100 acquires device information of the home appliance to which the feature command has been input. In addition, the personalization module 330 can extract personalized information corresponding to the device information, and in one embodiment, the personalized information can generate a third color set using information on one or more of a color set previously set in the device corresponding to the device information, the frequency of setting these color sets, or maintenance times of these color sets. In another embodiment, the personalized information can include information about one or more of a function set previously set for a home appliance corresponding to the device information, the frequency of the function set, or the duration of the function set.

To this end, the database can store identification information on the color set, time information, and device-specific identification information. In addition, the database can store information on the most recently applied color set.

The database stores color sets that have been set for each device. Accordingly, when the theme module 320 determines that the feature command is a user pattern-based recommendation, the personalization module 330 can perform calculations to recommend feature sets for each device. Consequently, different feature sets can be generated for each home appliance.

For example, when device_id is 1, after most frequently applied values for the color sets applied to device_id can be sorted, the color of the home appliance can be set as the next color different from the currently set color.
[Color 1, Color 2, Color 3, Color 4]

When device_id is 2, after the most frequently applied values for the color sets applied to device_id, the color of the home appliance can be set as the next color different from the currently set color.
[Color 13, Color 14, Color 15, Color 16]

For example, in the information stored in the database, when device_id is 1, “Iron Man” was applied twice, and the color set “Korea” is currently applied. Accordingly, when the user utterance command requests “Recommendation,” the personalization module 330 provides the color corresponding to “Iron Man” as a recommended color set.

Likewise, when device_id is 2, “Autumn Color” was applied twice, and “Autumn Color” is also applied for recommendation.

Meanwhile, the server 500 or the home appliance 100 can store the feature set generated by the theme module 320 as personalized information.

For example, when the feature set (e.g., Iron Man color) generated by the theme module 320 is repeatedly set in a device whose device_id is 1 or the maintenance time after setting is long, the server 500 or the home appliance 100 stores the feature command (Iron Man) and color information ([Color 1, Color 2, Color 3, Color 4]) in the database.

Then, when the user inputs a new command, the server 500 or the home appliance 100 loads and applies the information stored in the database.

For example, when the preprocessing module 310 processes the color command “Make it Iron Man color,” the “Iron Man” color and color information ([Color 1, Color 2, Color3, Color 4]) stored in the database after keyword extraction can be generated as the first color set.

Alternatively, when the personalization module 330 processes the color command “Make it Iron Man color,” the “Iron Man” color and color information ([Color 1, Color 2, Color3, Color 4]) stored in the database after keyword extraction can be generated as the third color set.

During this process, the server 500 or the home appliance 100 may not input a separate feature command to the theme module 320. That is, it is assumed that the second feature set generated in the operation S31 is applied to the home appliance 100 and maintained for a long time during the processes of performing the operations S21 to S51 of FIG. 3 once.

When the user utters the same feature command, the preprocessing module 310 of the home appliance 100 or the server 500 can process the feature command, or the operation S31 is omitted, and the personalization module 330 can load the stored feature set from the database in an operation S41.

That is, when the user utters the Iron Man color once and applies the Iron Man color to the home appliance 100 and the maintenance time or the number of times set repeatedly is a reference value, the server 500 or the home appliance 100 can store the corresponding feature command and feature set in the database to increase a processing speed of the utterance command of the user.

This is summarized as follows. The server 500 or the home appliance 100 stores the feature command and the second feature set in the database according to the maintenance time or the number of applications of the second feature set calculated by the theme module 320.

After performing the operations S21 to S51 of FIG. 3, the server 500 or the home appliance 100 can use the information stored in the database during the process in which the preprocessing module 310 generates the first feature set or the personalization module 330 generates the third feature set for the input feature command.

More specifically, the preprocessing module 310 can acquire information stored in the database to generate the feature set. Alternatively, the personalization module 330 can acquire the information stored in the database to generate the feature set.

For example, according to an embodiment, the method can enhance the accuracy and relevance of the generative AI's output by employing a contextual prompting process (e.g., one-shot or few-shot learning). When a user's command is to be interpreted by the theme module, a detailed prompt can be provided that includes the user's request along with one or more examples of different commands and their corresponding successful feature sets. This can provide the AI module with a clear model of the expected output format and logic. To further refine the results, the prompt can be augmented with additional context, such as the user's geographical region to account for cultural color associations, or device-specific parameters, such as the number of color panels on a refrigerator, ensuring the generated feature set is both contextually appropriate and physically compatible with the target appliance.

Further, according to an embodiment, the method can incorporate a dynamic learning mechanism that improves its efficiency and personalization over time. When the theme module successfully generates a new feature set that the user applies and maintains, this can be recognized as a user preference. This newly created association between the abstract command (e.g., Iron Man color) and the specific feature set (e.g., a list of hex color codes) can then be saved to a user specific database. In this way, the next time the user issues the same command, the system can bypass the generative AI process. Instead, the preprocessing or personalization modules can instantly retrieve the saved feature set from the database.

Hereinafter, a device implementing the embodiments of the present invention will be described.

The embodiments of the present invention can be implemented in various devices. The device includes various types of a server, a home appliance, an electronic device, a computing device, etc. In addition, the device of the present invention can include hardware or software components that perform the embodiments of the present invention in addition to physical devices. In addition, the embodiments of the present invention include programs, hardware, chips, and the like stored in a form capable of executing predetermined tasks or implemented in a form capable of executing the task.

Programs, software, and the like can be fixedly stored within the device or can be temporarily transmitted from an external source, stored in the device, and then executed. In the situation of the fixed storage method, the device can include a non-transitory computer readable medium.

That is, the embodiments of the present invention can be implemented as one or more computer programs or computer-readable storage media in a combination of one or more of the above ones.

The functions of the elements disclosed herein can be implemented using circuits or processing circuits including general-purpose processors, special-purpose processors, integrated circuits, application-specific integrated circuits (ASIC), existing circuits, and/or a combination thereof. The circuits can be processors configured or programmed to perform the disclosed functions. The processor can include transistors and other circuits and thus can be considered a processing circuit or circuit.

The circuits, units, or means herein can be hardware that performs or is programmed to perform the functions described in the detailed description. The hardware can be the hardware disclosed herein or other known hardware and can be hardware that is programmed or configured to perform the functions described in the detailed description. When the hardware is a processor, which can be considered a type of circuit, the circuits, means, or units can be a combination of hardware and software and can be software used to configure the hardware and/or the processor. In addition, the computer storage medium can be a non-transitory computer readable medium. For example, the computer storage medium can be executable by a cloud server-based system. The computer storage medium can be disposed within a single device or distributed across two or more different devices. Accordingly, a single logical computer storage medium can physically include two or more computer storage media, and positions at which these media are disposed can also be one or more positions. The computer storage medium includes various storage media such as a hard disk, a CD/DVD disk, a memory card, a memory chip, etc.

In addition, the data described herein can be calculated or performed in various environments, such as a cloud server-based system, an on-device system, a distributed server system (multiple servers), etc. The data can be processed in a distributed manner in a cloud server or executed locally on an on-device processor, and the results of the processing in each environment can be stored in non-volatile memory.

Electronic devices, such as home appliances, and server computing devices can be connected to one or more storage devices via a network. The storage device can be a combination of volatile and non-volatile memories and may or may not be disposed at the same physical position as the computing device.

The server computing device can include one or more processors and a memory. In this situation, the memory can store information accessible to the processor and include data that can be processed, stored, or modified by processor-executable commands. In addition, the memory can include volatile and non-volatile memories. The processor can include a central processing unit (CPU), a graphics processing unit (GPU), a field programmable gate array (FPGA), an ASIC, or a tensor processing unit (TPU).

Instructions can be configured to perform specific operations when the processor executes an instructed task and stored in object code or an interpretable script format. These commands can be used to implement the system and executed on a local or remote processor. Data can be retrieved, stored, or modified based on the commands and configured in a database, JSON, YAML, or XML format.

These commands can include executable files, source code files, metadata, etc.

Electronic devices including home appliances and hubs can be configured similar to a server computing device. The electronic devices including home appliances and hubs can include a processor, a memory, commands, data, and user input and output devices. The server computing device can transmit data to the electronic device, and the electronic device can display a portion of the received data through a display. In addition, data transmission and communication between the server computing device and the electronic device is possible via networks such as BLUETOOTH, Wi-Fi, wired and wireless networks, or the like, and direct and indirect communication between computing devices is possible, thereby supporting various protocols and connection methods.

In addition, the functions of the server computing device of the present invention can be performed by a smartphone, a tablet, etc.

The methods or processes in the embodiments of the present specification sequentially perform one or more tasks, and each task can be performed by either hardware or software or collaboration between the two. For example, hardware can perform a first task, and software can perform a second task. Of course, hardware can perform the entire task, or software can perform the entire task.

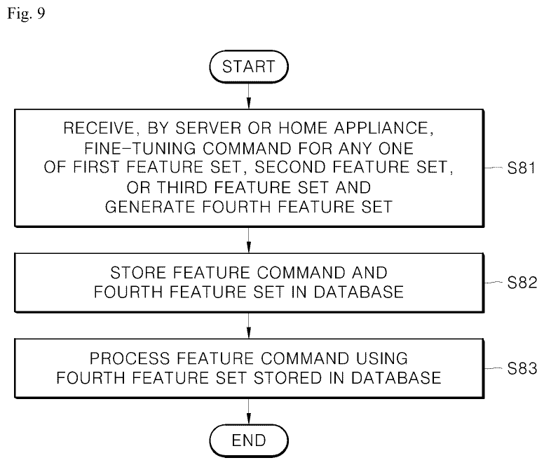

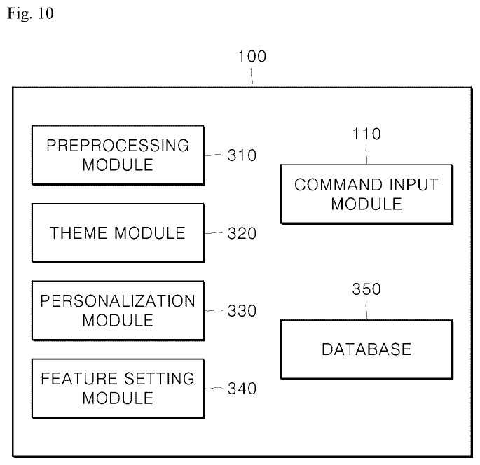

FIG. 9 is a view showing a processing process when fine-tuning a feature set occurs according to one embodiment of the present invention.

The server 500 or the home appliance 100 receives a fine-tuning command for one of the first feature set generated by the preprocessing module 310, the second feature set generated by the theme module 320, or the third feature set generated by the personalization module 330 and generates a fourth feature set (S81).

In this situation, the server 500 or the home appliance 100 stores the feature command and the fourth feature set in the database (S82). In addition, the server 500 or the home appliance 100 processes the feature command using the fourth feature set stored in the database for the subsequent input feature command (S83).

For example, after performing the operations S21 to S41 of FIG. 3, the server 500 or the home appliance 100 loads the fourth feature set stored in the database and sets the fourth feature set as the feature set of the home appliance during the process in which the preprocessing module 310 or the personalization module 330 generates a feature set for the input feature command.

When the above embodiments are applied, when the user wants to change the features (e.g., color, voice message, function) of the home appliance such as a refrigerator, an air conditioner, or the like, one of the feature set (e.g., a basic theme) provided by the home appliance by default in response to the text or voice command of the user, the feature set provided by the theme module such as a generative AI, and the feature set provided by the personalization module having a recommendation AI can be applied.

In addition, when the same voice/text commands for features (e.g., color values) generated by the theme module 320, such as a generative AI, accumulate, the voice/text commands can be stored in the database as the personalized feature set, thereby increasing efficiency during the process of modifying a feature.

For example, after a feature set is generated by any of the primary steps discussed above (e.g., NLP matching, AI theme-generated, personalized-generated, etc.), the user can issue a fine-tuning command to modify the result to his or her exact preference. This user adjusted feature set can be saved to a database and permanently associated with the original command. In this way, future instances of that same command can bypass the initial generation steps and directly apply the user's saved, fine-tuned version, allowing the system to learn and adapt to individual tastes over time for a faster and more accurate response.

The personalization module 330 can be implemented within the home appliance or the server 500, such as a cloud server. The theme module 320, which uses generative AI in one embodiment, can use an external generative AI server or can be implemented within the home appliance 100 or its own server 500.

Each module shown in FIG. 4 can be implemented in one of the home appliance 100 or the server 500. In addition, the theme module 320 can be disposed in a separate generative AI external server distinguished from the server 500.

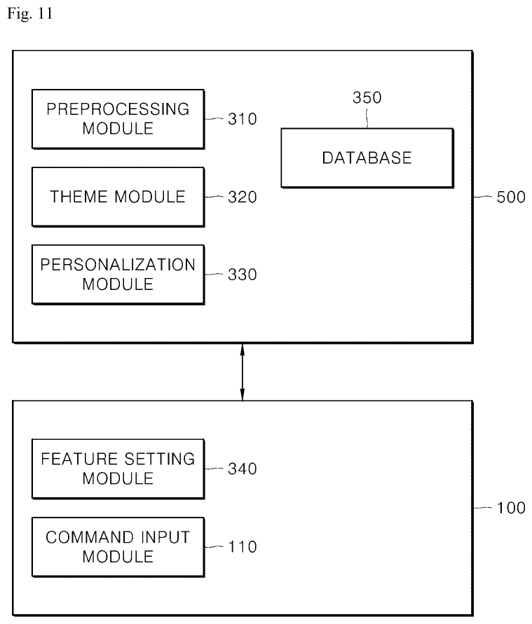

FIG. 10 is a view showing a configuration including all components within the home appliance according to one embodiment of the present invention.

The home appliance 100, which is one embodiment of the device, includes the preprocessing module 310, the theme module 320, the personalization module 330, and the feature setting module 340. A command input module 110 is a module that receives feature commands, such as voice, text, etc. The preprocessing module 310, the theme module 320, the personalization module 330, the feature setting module 340, and the database 350 are described above. The database 350 can store the personalized information of the device.

The feature setting module 340 sets one of the first, second, or third feature sets generated by the preprocessing module 310, the theme module 320, and the personalization module 330, respectively, as a feature.

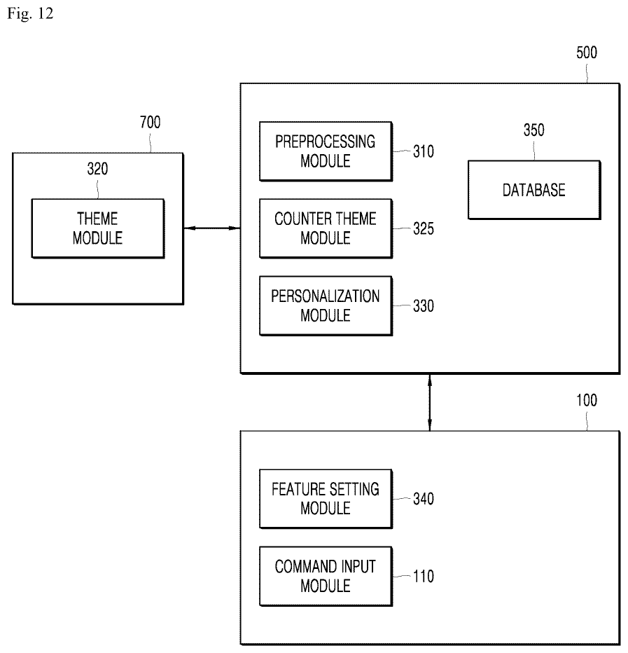

FIG. 11 is a view showing a server including a preprocessing module, a theme module, a personalization module, and a database according to another embodiment of the present invention. The server 500 and the home appliance 100 can include a communication module to transmit and receive predetermined information.

The server of FIG. 11 provides a personalized service using the generative AI. Regarding the detailed components of the server 500, the preprocessing module 310 receives the feature command received by the home appliance and calculates the first feature set and the first accuracy corresponding to the feature command.

When the first accuracy is the reference value or less, the theme module 320 calculates the second feature set and the second accuracy corresponding to the feature command. When the second accuracy is the reference level or less, the personalization module 330 calculates the third feature set using the personalized information corresponding to the device information of the home appliance and the feature command.

When the server 500 transmits one of the first, second, or third feature sets generated in this way to the home appliance 100, the home appliance 100 sets one of the feature sets as a feature of the home appliance. To this end, the feature setting module 340 can set the received feature set as a specific region or function of the home appliance 100.

When the feature set is a color set, the feature command corresponds to a color command. For example, when a preprocessing color command includes the color names of the colors constituting the first color set, the server 500, for example, the preprocessing module 310, can determine that the first accuracy for the first color set corresponds to the reference value. This is a situation in which a specific color name, such as orange or blue, is included in the color command. When a feature set is a function set, the feature command corresponds to a function command. For example, a preprocessing function command includes the function names of the functions constituting the first function set, the server 500, for example, a preprocessing module 310, can determine that the first accuracy for the first function set corresponds to the reference value. This is a situation in which a specific function name, such as setting the refrigerator temperature or turning the air conditioner on/off, is included in the function command. The above embodiment can be applied to a server 500 or a home appliance 100 including a preprocessing module 310.

In addition, the server 500 inputs a sample feature command and a sample feature set corresponding to the sample feature command to the theme module 320 in order to acquire a feature set using the theme module 320. In addition, the server 500 determines the second feature set and second accuracy generated by the theme module 320 and determines whether to input the feature command to the personalization module 330 based on the second feature set and the second accuracy.

When the user inputs a command such as “Recommend,” the theme module 320 can set the second accuracy very low.

As described above, the personalization module 330 of the server 500 can generate a color set using information on one or more of the color set previously set in the home appliance corresponding to the device information, the frequency of the set color set, or the maintenance time of the set color set.

In addition, in order to increase the accuracy of the result generated by the theme module 320, the server 500 can additionally input information on the region or country to which the user uttering the feature command belongs to the theme module 320. In addition, the age, gender, and occupation information of the user can also be additionally input to the theme module 320, thereby increasing the accuracy of the feature set generated in response to the feature command of the user.

The server 500 can transmit one of the generated feature sets to the home appliance 100, and the home appliance 100 can apply the transmitted feature set to the home appliance 100.

FIG. 12 is a view showing a server including a preprocessing module, a personalization module, and a database according to still another embodiment of the present invention. The server 500 and the home appliance 100 can include a communication module to transmit and receive predetermined information.

In addition, the theme module 320 is disposed in a separate generative AI external server 700 distinguished from the server 500. In this situation, unlike FIG. 11, the server 500 includes a counter theme module 325. The descriptions of other components will be made with reference to FIG. 11.

When the first accuracy generated by the preprocessing module 310 is the reference level or less, the counter theme module 325 transmits the feature command to the theme module 320 of the generative AI external server 700 and receives the second feature set and the second accuracy from the theme module 320.

In order to increase the accuracy of the result of the theme module 320, the counter theme module 325 transmits the sample feature command and the sample feature set corresponding to the sample feature command to the theme module 320. In addition, the counter theme module 325 receives the second feature set and the second accuracy corresponding to the feature command from the theme module 320.

The above embodiment can be implemented in a voice-recognizable device (e.g., an AI speaker, a hub, or the like) in addition to a remote controller or a main body of the home appliance 100 for voice recognition and intent identification. For example, the home appliance such as a refrigerator, an air conditioner, or the like can include only the feature setting module 340, and the home appliance such as an AI speaker, a hub, or the like can include the command input module 110.

In addition, the home appliance such as an AI speaker, a hub, or the like can include the preprocessing module 310, the theme module 320, and the personalization module 330. In this situation, the home appliance such as an AI speaker or a hub can transmit a device control signal to a related home appliance (or a device to be controlled).

As in the embodiment of FIG. 12, when the theme module 320, such as an LLM (GPT), is disposed on the external AI server 700, the theme module 320 cannot access a user database of a customer due to privacy or security issues. Accordingly, the embodiment of FIG. 12 can be implemented by separating the generative AI, the server (theme module), and the recommendation AI server (personalization module).

The theme module 320 and the personalization module 330 can generate a feature set for a feature command using the generative AI function (theme module) that reflects the linguistic characteristics of the user's society and a recommendation AI function (personalization module) based on personalized information. In addition, by applying the preprocessing module 310 and the personalization module 330, problems, such as increased costs or network latency during the use of the theme module 320 disposed in the external AI server 700, can also be resolved.

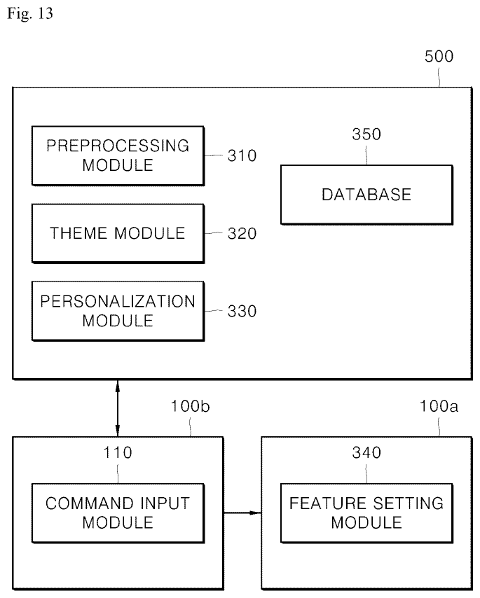

FIG. 13 is a view showing a configuration of a home appliance, a home appliance for voice processing, and a server according to one embodiment of the present invention.

The AI speaker, the hub, or the like is a home appliance 100b for voice processing and includes a command input module 110. In this situation, the home appliance 100b for voice processing can communicate with the server 500, receive the feature set, and provides the feature set to a home appliance 100a, such as a refrigerator, an air conditioner, an oven, or the like, thereby controlling the feature settings of the home appliance 100a.

Alternatively, when combining the embodiments of FIGS. 10 and 13, the home appliance 100b for voice processing can include the preprocessing module 310, the theme module 320, the personalization module 330, and the command input module 110. In addition, the home appliance 100a, such as a refrigerator, an air conditioner, an oven, or the like, can include the feature setting module 340.

The present invention is not limited to a specific home appliance and can be applied to all home appliances that include the feature setting module 340 that sets the color, the type of voice message, and a function as described above.

In the embodiments of FIGS. 11 and 13, the preprocessing module 310, the theme module 320, and the personalization module 330 can constitute a single processor.

In the embodiment of FIG. 12, the preprocessing module 310, the counter theme module 325, and the personalization module 330 can constitute a single processor.

Based on the embodiments of FIGS. 11 to 13, the processor of the server can process information received from the home appliance and input the processed information to the theme module 320, which is the generative AI model, to acquire a result. The processor can receive a feature command instructing a feature change of the first home appliance from the first or second home appliance.

In addition, the processor can generate a prompt including at least one of configuration information of the first home appliance, the state information of the first home appliance, and the feature command in response to the feature command.

The processor can input the generated prompt to the theme module 320 to acquire a result and convert the acquired result into the first feature set to be set in the first home appliance.

Here, the second home appliance can be a user terminal or a home appliance other than the first home appliance. For example, a smart hub, a smart AI speaker, or the like can be the second home appliance, and in this situation, the voice/text command of the user for converting the feature set of the first home appliance (e.g., a refrigerator or an air conditioner) can be transmitted to the server 500 through the second home appliance.

The user's command can be input via voice or text, and the device receiving the command and transmitting the command to the server can be the first home appliance instructed to change the feature set or a separate second home appliance (e.g., a user terminal, an AI speaker, or the like).

As described above, the feature command is a command instructing a color change of the first home appliance in one embodiment.

The feature set includes information on one or more colors to be set in the first home appliance.

The configuration information is information on a region of the first home appliance to which one or more colors will be set. For example, information on a specific color being set in a refrigerator compartment door corresponds to the configuration information.

The state information includes information on the second feature set currently or previously set in the first home appliance.

The result acquired from the theme module 320 can include two or more candidate feature sets.

The processor can apply one or more of the configuration information, the state information, and the feature command to convert one of two or more candidate feature sets into the first feature set.

In addition, the processor can transmit the first feature set to the first home appliance or transmit the feature control command to apply the first feature set to the first home appliance to the first home appliance. The processor can transmit the first feature set to the first home appliance through the second home appliance.

To this end, the processor can store software or program code capable of performing the above tasks. After such software or program code is received from another external device and stored in a storage medium used by the processor, the processor can execute the software or program code.

In addition, the processor can include a hardware component, such as a programmable chip, and the processor can store data, program code, and the like, which will be input to the hardware component, in a predetermined storage medium and input the data, the program code, and the like to the hardware component.

The hardware or software can be the processor itself. Alternatively, the hardware or software can be linked with the processor to implement embodiments of the present invention.

In the embodiments of FIGS. 11 to 13, the server 500 or the home appliance 100 can include modules in various combinations. These modules can be implemented in hardware or software, and to this end, each module can be implemented in one storage medium or a plurality of storage mediums. In addition, the storage medium can be implemented separately in the server 500 and the home appliance 100.

Accordingly, the storage medium installed in the server 500 or the home appliance 100 can include the preprocessing module 310 and the personalization module 330. In addition, the storage medium can include one of the theme module 320 or the counter theme module 325.

The preprocessing module 310 generates the first feature set and the first accuracy corresponding to the feature command.

When the first accuracy is the reference value or less, the theme module 320 can generate the second feature set and the second accuracy corresponding to the feature command.

When the first accuracy is the reference value or less, the counter theme module 325 can transmit the feature command to the theme module 320 of the generative AI external server 700 and receive the second feature set and the second accuracy from the theme module 320.

When the second accuracy is the reference value or less, the personalization module 330 can generate the third feature set using the personalized information and the feature command corresponding to the device information of the home appliance.

In addition, the storage medium can control the home appliance to set the features of the home appliance. The storage medium can provide the feature setting module 340 of the home appliance 100 with information necessary for feature settings.

Accordingly, FIGS. 11 to 13 include embodiments of the configuration of a computer-readable and executable storage medium. FIGS. 11 to 13 include embodiments of the configuration of hardware or software implemented in the server 500 or the home appliance 100.

When applying the embodiments of FIGS. 11 to 13, existing, older home appliances (e.g., 100a) without an AI function can also be connected to a service (e.g., ThinQ On) that provides a feature set through the server 500 that performs voice processing and generates a feature set or the home appliance 100b for voice processing.

Consequently, the feature set can be provided to allow the generative AI to understand the context of the user's commands and operate smoothly, and the home appliance 100a can be upgraded to an AI appliance. Consequently, the user can combine ThinQ On with IoT devices to implement a reasonable AI home with existing home appliances, eliminating the need to purchase all new AI appliances.

For example, it is assumed that a customer connects an existing air conditioner without an AI function and an occupancy sensor that detects a space to ThinQ On that provides a feature set. Since ThinQ On generates the feature set in response to the feature command, the user's position can be identified in real time, and the airflow and direction of the air conditioner can be adjusted to deliver optimal airflow for a customer. The existing air conditioners can be upgraded to powerful AI air conditioners by being combined with LG ThinQ On without purchasing a new, expensive, state-of-the-art AI air conditioner.

The server 500 according to the embodiment of the present invention can provide an AI service and include the database 350 that stores past personalized or routine information on the customer.

By using an LLM such as ChatGPT and a server including user experience data, such as usage patterns of an electronic device of the user, an optimized space solution can be provided to each individual based on learning about the user's lifestyle. For example, when the user uses a feature command such as “I studied well last week, so please set it the same way,” the settings stored in the database 350 can be loaded to establish a personalized environment.

In one embodiment of the present invention, the server 500 includes a server cluster, which is a collection of various servers in an embodiment. Accordingly, the configuration of the server 500 can be easily changed by those skilled in the art.

In one embodiment, the server 500 in the embodiments of FIGS. 11 to 13 can provide the function of an NLP server. For example, the server 500 can include the preprocessing module 310, the counter theme module 325 or the theme module 320, etc. In addition, the server 500 can perform a task to input a predetermined prompt message to the theme module 320. That is, in order to acquire accurate answers through the LLM model such as ChatGPT, the server 500 can structure the prompt content and embed and store an utterance DB.

As show in FIG. 12, when the theme module 320 is implemented in the external AI server 700, the server 500 can efficiently generate prompt tokens, thereby securing maximum performance for the theme module 320 using GPT as an example at low cost, with low network latency, etc. The NLP server can be implemented inside the server 500 or as a separate cloud server (e.g., a cloud server of Amazon Web Services (AWS)).

In the embodiment shown in FIG. 12, the server 500 can incur costs during the process of inputting a predetermined prompt message to the external AI server 700 and acquiring the corresponding result. Accordingly, when the server 500 fine-tunes and trains the preprocessing module 310 and the personalization module 330 as much as possible in response to the feature command and stores the results in the database, the number of times the external AI server 700 is used can be reduced.

For example, in the embodiment of FIG. 12, when the server 500 fine-tunes and trains utterance data instead of using the costly GPT application protocol interface (API), the server 500 can process the feature commands using the internal modules 310 and 330 without using a GPT API.

The fine-tuning according to one embodiment of the present invention includes developing and applying a dedicated model specialized for a home appliance (e.g., a specific home appliance such as a refrigerator, an air conditioner, or the like) using a small language model (sLM).

When the performance of the AI chip installed in the home appliance 100 is ensured, the service can also be provided in the on-device format as shown in FIG. 10.

In addition, the theme module 320 according to one embodiment of the present invention can apply an LLM. For example, the theme module 320 can interpret the meaning of utterance using NLP and output corresponding intents and slots based on the input prompt and sample data.

The LLM such as GPT can provide overwhelming performance in terms of processing speed and data volume because the LLM is supported by a high-performance data center. Accordingly, the theme module 320 can be disposed within the server 500 or implemented in the external AI server 700 as shown in FIG. 12.

In one embodiment, the external AI server 700 is a server 700 that implements ChatGPT, MS Azure GPT, GPT-40 mini, or the like provided by Open AI. A query, for example, a prompt, can be input to the external AI server 700, and the results can be received using an API. For example, the counter theme module 325 of FIG. 12 can acquire a feature set corresponding to a feature command using the API provided by the theme module 320.

When the embodiment of the present invention is applied, the theme module 320 having AI that performs NLP, such as GPT, can identify the intent of the feature command uttered by the user and provide the result (feature set) indicating whether the user desires a recommendation or a specific feature combination.

In addition, when a prompt engineering technology is applied to the feature command to be input to the theme module 320, performance comparable to fine-tuning can be achieved through only prompt engineering without finely tunning the entire GPT AI model.

A mood-enhancing home appliance, for example, a refrigerator, an air conditioner, can be combined with the generative AI (GPT) to accurately identify the intents of various user utterances and set desired features (e.g., a set of various color themes, voice tones (speech tones), and functions).

The preprocessing module 310 can pre-define a feature set corresponding to a specific utterance of the user and has been trained to recognize this, enabling it to quickly process commands for pre-defined features (e.g., a specific color theme).

Meanwhile, when the user desires a feature set not defined in the preprocessing module 310, the theme module 320, such as an LLM (GPT), can be applied. In this situation, prompt engineering can also be applied to non-predefined commands (feature commands) to set a large number of feature sets. For example, when receiving a color command, the theme module 320 can recognize various natural language related to a color theme change and extract themes related to the color.

The theme module 320 can include one or more LLMs, such as Microsoft's GPT, a third-party LLM module, an LLM developed by LG, etc. In addition, the server 500 does not necessarily need to include the theme module 320, and the theme module 320 can be included in a separate LLM server provided by an external service provider or LG.

By applying the embodiment of the present invention, the server 500 can provide an accurate feature set by identifying the intent of the user input feature command through a structure that couples the LLM (GPT) server (theme module) to the recommendation AI server (personalization module) in addition to the NLP server (preprocessing module).

In one embodiment, when the user says, “Change a color to a so-cool color,” the preprocessing module 310 can change the color set defined as a summer theme color to a summer theme color. In addition, when the user says, “The weather is really hot, change a color to a very cool color,” and the corresponding color set is not defined in the preprocessing module 310, the theme module 320 can identify the user intent and generate a color theme.

That is, when the embodiment of the present invention is applied, the preprocessing module 310 and the theme module 320 can be coupled to identify the user intent and generate a feature set reflecting the intent. To this end, prompt engineering can be used to include the sample feature commands and the sample feature shots in the prompt, allowing the theme module 320 to generate feature values (e.g., color values) that reflect the user intent.

In addition, the theme module 320 can secure information on feature sets commonly accepted by the corresponding society or country. For example, the theme module 320 can provide a color therapy function and generate a color theme that can provide appropriate psychological stability when a user utters, “I'm feeling depressed, change the color.”

Meanwhile, when the preprocessing module 310 and the theme module 320 fail to generate the feature set that corresponds to the user intent, the personalization module 330 can use user information (e.g., information on the device usage of the user) to provide a customized feature set based on the user's past or current feature set in the home appliance. In this situation, the exterior of the home appliance can be changed to a color the user likes or prefers.

Since the theme module 320 does not store user-related information, the personalization module 330 can use user-related information to provide a user-specific feature set.

The personalization module 330 can generate a color theme suitable for the user when the user inputs a feature command, such as “Change a color to a color that suits me.”

The recommendation AI server, which is an example of the personalization module 330, determines whether a user's utterance requires an AI recommendation through the theme module 320, for example, the LLM (GPT).

In addition, when it is determined that a recommendation is desired (e.g., when the feature set generated by the theme module such as an LLM does not meet the criteria), the recommendation AI server can recommend a color theme based on the usual usage patterns of the user.

For example, when the user desires a recommendation for a refrigerator color theme, the personalization module 330, for example, the recommendation AI server, can generate a color theme, thereby increasing a success rate of responding to the color theme change command (color command) of the user and enhancing satisfaction with the generated color theme.

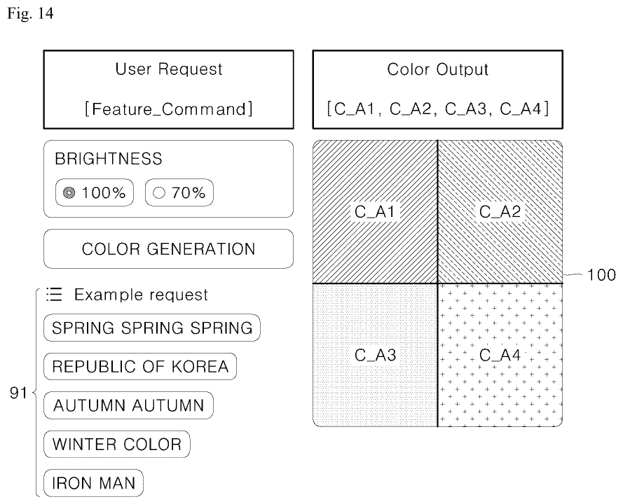

FIG. 14 is a view showing an interface for changing colors in response to user input commands according to one embodiment of the present invention.

The user inputs a feature command to a smartphone, a tablet, or a refrigerator 100a via voice or text. The feature command (Feature_Command) input in the “User Request” field can be displayed. For example, a command, such as “I'm angry, so change a color to a calming color,” “Change a color to Iron Man color,” or “Recommend a color that suits me today,” is input.

The preprocessing module 310, the theme module 320, or the personalization module 330 of the server 500 or the home appliance 100a processes the input command and generates a color output. In FIG. 14, “C_A1, C_A2, C_A3, C_A4” is an example of a color set. In addition, each of the color sets can be applied to the exterior of the refrigerator 100a to which the colors will be applied. The order of application can be determined in advance.

91 can represent a theme of colors previously used by the user or represent the names of colors or the like that the preprocessing module 310 can process.

The user can input information on whether to maintain or change the applied color using the interface of the home appliance 100a or a smartphone/tablet. The input information (maintaining or changing) is stored in the personalization module 330.

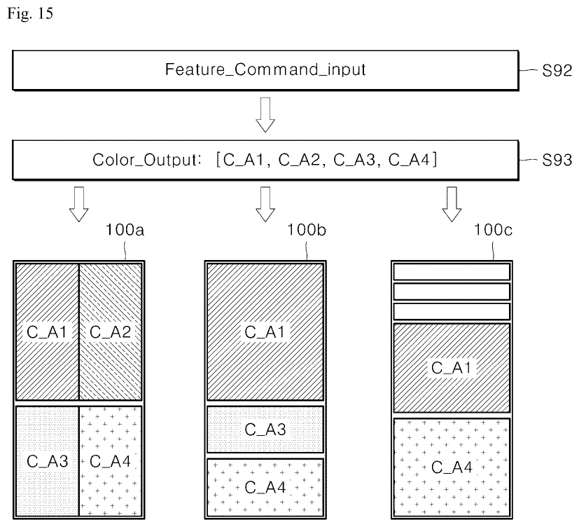

FIG. 15 is a view showing a process of changing colors of a plurality of home appliances according to one embodiment of the present invention.

The user inputs a feature command via voice (S92). For example, the user inputs a voice command such as “The weather is really hot, so change the color to a very cool theme!” using one of the home appliances 100a, 100b, and 100c or a smartphone/tablet (S92).

The server 500 or one of the home appliance 100a, 100b, and 100c performs the process described in FIG. 3 and the like and generates a feature set (e.g., a color set) corresponding to the feature command (S93). When the result is “[C_A1, C_A2, C_A3, C_A4],” the color set can be applied to a plurality of home appliances.

For example, all four colors are applied to the refrigerator 100a. On the other hand, a kimchi refrigerator 100b, which has three color panels, applies three colors, such as “[C_A1, C_A3, C_A4].” An air conditioner 100c applies two colors, such as “[C_A1, C_A4].”

When the user gives a single voice command, a consistent color theme can be applied to all home appliances 100a, 100b, and 100c in the home connected to the user's account on the server 500, for example, the ThinQ server.

In summary, in response to the feature command of the user, the home appliance 100 or the server 500 can apply one of the first feature set generated through the preprocessing module 310, the second feature set generated through the theme module 320, or the third feature set generated through the personalization module 330 to another home appliance connected to the user's account of the home appliance 100, thereby applying consistent features to home appliances owned or used by the user.

For example, according to an embodiment, the method can enable a use to synchronize a consistent theme across multiple home appliances using a single command. In response to a user's request, the method can generate a unified feature set and distributes it to all connected devices. Each appliance can then intelligently adapt this master feature set to its own specific capabilities to create a harmonized aesthetic and functional experience throughout the user's entire smart home environment.

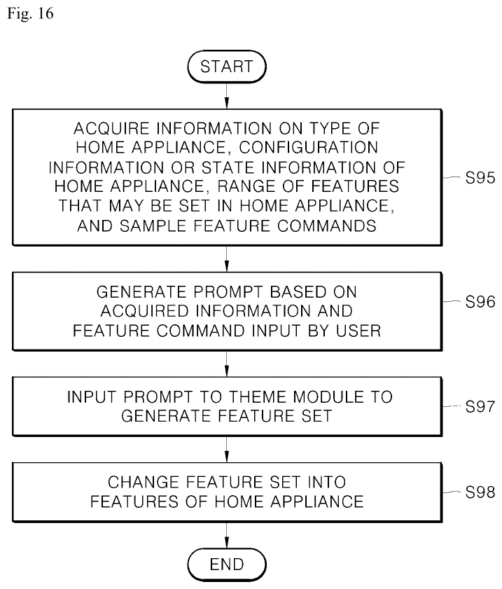

FIG. 16 is a view showing a process of changing features of a home appliance according to one embodiment of the present invention.

The process of FIG. 16 can be performed independently by one of the home appliance 100 or the server 500 or by both devices working together.

The home appliance 100 or the server 500 acquires information on the type of the home appliance, configuration information or state information of the home appliance, the range of features that can be set in the home appliance, and sample feature commands (S95). In addition, the home appliance 100 or the server 500 generates a prompt based on the acquired information and the feature command input by the user (S96). Then, the home appliance 100 or the server 500 inputs the prompt to the theme module 320 to generate a feature set (S97). In addition, the home appliance 100 or the server 500 changes the feature set into features of the home appliance (S98). The feature setting module 340 of the home appliance 100 can set the generated feature set as the features of the home appliance 100.

In one embodiment, when controlling the function of an air conditioner, the home appliance 100 or the server 500 can set various information on the air conditioner (e.g., information on type, configuration information, state information, the range of a controllable function, sample function control command).

In addition, the home appliance 100 or the server 500 can generate a prompt based on the acquired information and the feature commands related to the functions input by the user.

Thereafter, the home appliance 100 or the server 500 can input the prompt to the theme module 320 using an LLM as an example and then acquire a command (control command) for controlling the function. The theme module 320 can be implemented in the home appliance 100, the server 500, or the external server 700.

Thereafter, the home appliance 100 or the server 500 can control the air conditioner using the acquired control commands. During this process, the home appliance 100 or the server 500 can repeat the process of acquiring information (S95) to respond to subsequent feature commands.

Even though all components constituting the embodiments of the present invention have been described as being coupled or coupled and operated, the present invention is not necessarily limited to these embodiments, and one or more of all components can be selectively coupled and operated without departing from the scope of the present invention. In addition, each of the components can be implemented as a single, independent hardware, but some or all of the components can be selectively coupled and implemented as a computer program having program modules that perform some or all of the combined functions of one or more hardware units. The codes and code segments constituting the computer program can be easily inferred by those skilled in the art. Such a computer program can be stored in a computer-readable storage medium and read and executed by a computer, thereby implementing the embodiments of the present invention. The storage media for computer programs include magnetic recording media, optical recording media, and storage media including semiconductor recording devices. In addition, a computer program implementing the embodiments of the present invention includes program modules transmitted in real time through an external device.

The above description focuses on the embodiments of the present invention, but various changes and modifications can be made within the scope of those skilled in the art. Accordingly, it will be understood that these changes and modifications are included within the scope of the present invention as long as they do not depart from the scope of the present invention.

What is claimed is:

1. A method of changing a feature of a home appliance, comprising:
receiving, by a server or the home appliance, a feature command;
generating, by the server or the home appliance, a first feature set and a corresponding first accuracy based on the feature command;
in response to determining that the first accuracy is less than or equal to a first predetermined reference value, generating, by the server or the home appliance, a second feature set and a corresponding second accuracy based on the feature command using an artificial intelligence (AI) theme module;
in response to determining that the second accuracy is less than or equal to a second predetermined reference value, generating, by the server or the home appliance, a third feature set based on the feature command and personalized information corresponding to the home appliance; and
changing the feature of the home appliance to correspond to one of the first feature set, the second feature set and the third feature set based on at least one of the first accuracy and the second accuracy.

2. The method of claim 1, wherein one of the first feature set, the second feature set and the third feature set includes a color set, a speech set, or a function set.

3. The method of claim 1, further comprising, in response to the feature command being a color command that includes one or more color names of colors constituting a color set of the first feature set and the first accuracy being greater than the first predetermined reference value, changing the feature of the home appliance to correspond to the first feature set.

4. The method of claim 1, wherein the generating the second feature set includes inputting, to AI theme module, the feature command, at least one sample feature command, and at least one sample feature set corresponding to the at least one sample feature command to generate the second feature set.

5. The method of claim 1, further comprising, in response to the feature command being a color command and the second accuracy being less than or equal to the second predetermined reference value, changing the feature of the home appliance to correspond to the third feature set,
wherein the personalized information includes information on one or more of a color set previously set in the home appliance, a frequency of a color set, or a maintenance time of the color set.

6. The method of claim 1, wherein the generating the second feature set includes inputting, to the AI theme module, information on a region or country corresponding to a user that provided the feature command to generate the second feature set.

7. The method of claim 1, wherein one or more of the first, second and third features sets include feature information and information on a region or function of a device in which the feature information will be set.

8. The method of claim 1, further comprising:
storing, by the server or the home appliance, the feature command and the second feature set as information stored in a database according to a maintenance time or a number of applications of the second feature set; and
in response to receiving a subsequent feature command that corresponds to the information stored in the database, setting, by the server or the home appliance, the information stored in the database as the first feature set or the third feature set during a process of generating the first feature set or the third feature set.

9. The method of claim 1, further comprising:
receiving, by the server or the home appliance, a fine-tuning command for any one of the first feature set, the second feature set, or the third feature set and generating a fourth feature set;
storing the feature command and the fourth feature set in a database; and
in response to receiving a subsequent feature command that corresponds to the feature command, changing the feature of the home appliance to correspond to the fourth feature set.

10. The method of claim 1, further comprising applying, by the server or the home appliance, any one of the first feature set, the second feature set, or the third feature set to another home appliance connected to a user account of the home appliance.

11. The method of claim 1, further comprising inputting, by the server or the home appliance, at least one of a type of home appliance targeted by the feature command, configuration information of the home appliance or state information of the home appliance, a range of settable features for the home appliance, and sample control commands to the AI theme module.

12. A method of changing a feature of a home appliance, the method comprising:
receiving, by a processor, a feature command for a first home appliance from the first home appliance or a second home appliance;
generating, by the processor, a prompt including the feature command and configuration information of the first home appliance;
providing the prompt to an artificial intelligence (AI) theme module to generate a result; and
converting the result into a first feature set for changing the feature of the first home appliance based on the first feature set.

13. The method of claim 12, wherein the prompt further includes state information of the first home appliance.

14. The method of claim 12, wherein the second home appliance is a user terminal or a home appliance different than the first home appliance.

15. The method of claim 12, wherein the feature command is a command instructing a change in a color of the first home appliance, and
wherein the first feature set includes information on one or more colors to be set in the first home appliance.

16. The method of claim 15, wherein the prompt further includes state information of the first home appliance,
wherein the configuration information is information on a region of the first home appliance to which the one or more colors are to be set, and
wherein the state information includes information on a second feature set currently or previously set in the first home appliance.

17. The method of claim 12, wherein the prompt further includes state information of the first home appliance,
wherein the result includes a plurality of candidate feature sets, and
wherein the converting the result into the first feature set includes selecting, by the processor, one of the plurality of candidate feature sets as the first feature set based on at least one of the configuration information, the state information, or the feature command.

18. The method of claim 12, further comprising transmitting, by the processor, the first feature set to the first home appliance or transmitting a feature control command to apply the first feature set to the first home appliance.

19. A non-transitory computer readable medium storing computer-executable instructions that when executed by a processor, cause the processor to perform the operations of:
receiving a feature command for changing a feature of a home appliance;
determining whether the feature command matches a first feature set stored in a database;
in response to failing to match the feature command to the first feature set, providing the feature command to an artificial intelligence (AI) theme module to generate a second feature set;
in response to the AI theme module failing to generate the second feature set, generating a third feature set based on personalized user information; and
changing the feature of the home appliance to correspond to one of the first feature set, the second feature set, or the third feature set.

20. The non-transitory computer readable medium of claim 19, wherein the instructions further cause the processor to perform the operations of:
generating a first accuracy score based on the determining whether the feature command matches the first feature set;
in response to the first accuracy score being greater than a first predetermined reference value, changing the feature of the home appliance to correspond to the first feature set;
in response to the first accuracy score being less than or equal to the first predetermined reference, providing the feature command to the AI theme module to generate the second feature set and generating a second accuracy score corresponding to the second feature set;
in response to second accuracy score being greater than a second predetermined reference value, changing the feature of the home appliance to correspond to the second feature set; and
in response to the second accuracy score being less than or equal to the second predetermined reference, changing the feature of the home appliance to correspond to the third feature set based on the personalized user information.
